(19) United States
(12) Patent Application Publication
(10) Pub. No.: US 2013/0332375 A1
(43) Pub. Date: Dec. 12, 2013

(54) METHODS AND APPARATUS FOR ANALYSIS AND MAINTENANCE OF COLLATERAL

(71) Applicant: MARK H. FACKLER, Louisville, KY (US)

(72) Inventor: MARK H. FACKLER, Louisville, KY (US)

(21) Appl. No.: 13/492,476

(22) Filed: Jun. 8, 2012

(51) Int. Cl. G06Q 50/16

(52) U.S. Cl. 705/314

(57) ABSTRACT

Methods and apparatus related to analysis and/or maintenance of collateral to enable mitigation of risks related to the collateral. Some implementations enable a user to monitor and assess the condition and estimated mitigation costs for one or more properties.

### CROSS-REFERENCE TO RELATED DOCUMENTS

Not Applicable.

### TECHNICAL FIELD

The present invention is directed generally to the analysis and maintenance of collateral. More particularly, various inventive methods and apparatus disclosed herein relate to analysis and maintenance of collateral to enable mitigation of risks related to the collateral.

### BACKGROUND

The real estate industry often fails to appreciate exposures to real estate collateral and/or disregards exposures to real estate collateral. Exposures to real estate collateral may include those related to physical deterioration, vandalism, waste disposal, and/or theft that are often associated with distressed and/or abandoned real estate. Such exposures may include potential financial exposures directly related to damage of the real estate (e.g., the immediate and secondary damage caused by a leaking roof) and/or potential liability exposures related to failure to mitigate conditions of the real estate (e.g., potential danger to neighboring real estate and/or individuals posed by improperly stored chemicals). Failure to properly recognize and address such exposures may result in depreciating collateral valuations and increased liability exposures.

### SUMMARY

The present disclosure is directed to analysis and/or maintenance of collateral to enable mitigation of risks related to the collateral. For example, some implementations are directed to methods and apparatus to allow a user to monitor and assess the condition and/or estimated mitigation costs for one or more properties.

Generally, in one aspect, a computer implemented method for monitoring real estate collateral is provided and includes the steps of: receiving collateral audit form data, the collateral audit form data including on-site analysis data verified via on-site analysis of the real estate collateral; analyzing the collateral audit form data; creating an action item for the real estate collateral; determining an initial risk level for the action item; calculating a potential exposure cost for the action item; estimating a mitigation cost for the action item; assigning a risk level trigger to the action item, the risk level trigger based on at least one of a calendar date, a status milestone related to the real estate collateral, geographic location of the real estate collateral, and a specific condition of the real estate collateral; raising, utilizing one or more processors, the initial risk level to an elevated risk level in response to the risk level trigger occurring; and creating a user notification of the elevated risk level.

In some embodiments assigning the initial risk level for the action item is based on at least one of a current calendar date, current status milestones related to the real estate collateral, the geographic location of the real estate collateral, and current specific conditions of the real estate collateral.

In some embodiments the potential exposure cost for the action item is estimated, utilizing one or more processors, and is based on analysis of a database of similar potential exposure costs.

In some embodiments the estimated mitigation cost for the action item is estimated, utilizing one or more processors, and is based on analysis of a database of similar estimated mitigation costs.

In some embodiments the method further includes the step of receiving a mitigation bid for the action item and replacing the estimated mitigation cost with the mitigation bid.

In some embodiments the method further includes the step of automatically soliciting, utilizing one or more processors, bids from a plurality of contractors. In some versions of those embodiments the step of automatically soliciting is performed in response to the step of raising the initial risk level to the elevated risk level.

Generally, in another aspect, a computer implemented method for monitoring real estate collateral is provided and includes the steps of: receiving collateral audit form data for real estate collateral, the collateral audit form data including on-site analysis data verified via on-site analysis of the real estate collateral; analyzing the collateral audit form data to create an action item for the real estate collateral; determining an initial risk level for the action item; determining a potential exposure cost for the action item; determining an estimated mitigation cost for the action item; and assigning a risk level trigger to the action item; raising, utilizing one or more processors, the initial risk level to an elevated risk level in response to the risk level trigger occurring; creating and transmitting a user notification containing the elevated risk level; receiving a notification of completion of the action item and assigning a completed status to the action item in response to receiving the notification of completion; creating a second action item for the real estate collateral; receiving a second action item notification of completion of the second action item and assigning a second action item completed status to the second action item in response to receiving the second action item notification of completion; wherein the second action item notification of completion is only assignable when the completed status is assigned to the action item.

In some embodiments the action item is a collateral preservation action item related to at least one of physically fixing and physically maintaining the real estate collateral.

In some embodiments the action item is a legal action item related to legal requirements for processing of the real estate collateral.

In some versions of those embodiments the second action item is a collateral preservation action item related to at least one of physically fixing and physically maintaining the real estate collateral.

In some embodiments the method further includes automatically soliciting, utilizing one or more processors, bids from a plurality of contractors for the second action item. In some versions of those embodiments the step of automatically soliciting is only performed when the completed status is assigned to the action item.

In some embodiments the risk level trigger is based on at least one of a calendar date, a status milestone related to the real estate collateral, geographic location of the real estate collateral, and a specific condition of the real estate collateral.

In some embodiments the risk level trigger is based on the status milestone related to the real estate collateral. In some versions of those embodiments the status milestone related to the real estate collateral includes at least one of special servicing, pre-foreclosure, vacate, utilities cut, and real estate owned.

In some embodiments the method further includes automatically assigning the initial risk level for the action item based on at least one of a current calendar date, current status milestones related to the real estate collateral, the geographic location of the real estate collateral, and current specific conditions of the real estate collateral.

In some embodiments the potential exposure cost for the action item is automatically determined, utilizing one or more processors, and is based on analysis of a database of similar potential exposure costs. In some versions of those embodiments the estimated mitigation cost for the action item is automatically determined, utilizing one or more processors, and is based on analysis of a database of similar estimated mitigation costs.

In some embodiments the step of receiving the notification of completion of the action item and assigning a completed status to the action item in response to receiving the notification of completion includes receiving and storing an invoice of work related to the action item.

Other implementations may include a non-transitory computer readable storage medium storing instructions executable by a processor to perform a method such as one or more of the methods described above. Yet another implementation may include a system including memory and one or more processors operable to execute instructions, stored in the memory, to perform a method such as one or more of the methods described above.

Particular implementations of the subject matter described herein process information pertaining to collateral for potential utilization in one or more collateral risk management systems. This information represents data that is derived from observation of actual physical collateral. The data is processed by one or more systems to provide meaningful information pertinent to mitigation of risks to the collateral.

It should be appreciated that all combinations of the foregoing concepts and additional concepts discussed in greater detail herein are contemplated as being part of the inventive subject matter disclosed herein. For example, all combinations of claimed subject matter appearing at the end of this disclosure are contemplated as being part of the inventive subject matter disclosed herein.

### BRIEF DESCRIPTION OF THE DRAWINGS

FIG. 1 is a block diagram of an example environment in which one or more methods related to monitoring collateral and/or mitigating risks to collateral may be implemented.

FIG. 2 is a flow chart illustrating an embodiment of a method of creating one or more action items for collateral.

FIG. 3 is a flow chart illustrating another embodiment of a method of creating one or more action items for collateral.

FIG. 4 is a flow chart illustrating an embodiment of monitoring risks for collateral and mitigating the risks for the collateral.

FIG. 5 illustrates a block diagram of an example computer system.

FIGS. 6A-6A1 illustrate aspects of an example graphical user interface that may be implemented in an embodiment of a collateral audit engine.

FIGS. 7A-7K illustrate examples of additional options that are available through selection of the drop down fields of the graphical user interface of FIGS. 6A-6A1.

FIG. 8A illustrates aspects of an example collateral navigator overall status dashboard graphical user interface that may be implemented in an embodiment of a collateral information engine.

FIGS. 8B-8E illustrate aspects of an example collateral services navigator graphical user interface that may be implemented in an embodiment of a collateral information engine.

FIGS. 8F and 8G illustrate aspects of an example third party collateral services navigator graphical user interface that may be implemented in an embodiment of a collateral information engine.

FIG. 8H illustrates aspects of an example tangible collateral services navigator graphical user interface that may be implemented in an embodiment of a collateral information engine.

FIG. 9A illustrates an example action notification for a collateral services security action.

FIG. 9B illustrates an example action notification for a collateral services residual food action.

FIG. 9C illustrates an example action notification for a collateral services boiler maintenance action.

FIG. 9D illustrates an example action notification for a collateral services pipe winterization action.

FIG. 9E illustrates an example action notification for a collateral services leaking roof action.

FIG. 9F illustrates an example action notification for a third party services former auto service and gas operations action.

FIG. 9G illustrates an example action notification for a third party damaged asbestos action.

### DETAILED DESCRIPTION

In the following detailed description, for purposes of explanation and not limitation, representative embodiments disclosing specific details are set forth in order to provide a thorough understanding of the claimed invention. However, it will be apparent to one having ordinary skill in the art having had the benefit of the present disclosure that other embodiments according to the present teachings that depart from the specific details disclosed herein remain within the scope of the appended claims. Moreover, descriptions of well-known methods and apparatuses may be omitted so as to not obscure the description of the representative embodiments. Such methods and apparatuses are clearly within the scope of the claimed invention. However, other configurations, applications, and implementations are contemplated without deviating from the scope or spirit of the claimed invention.

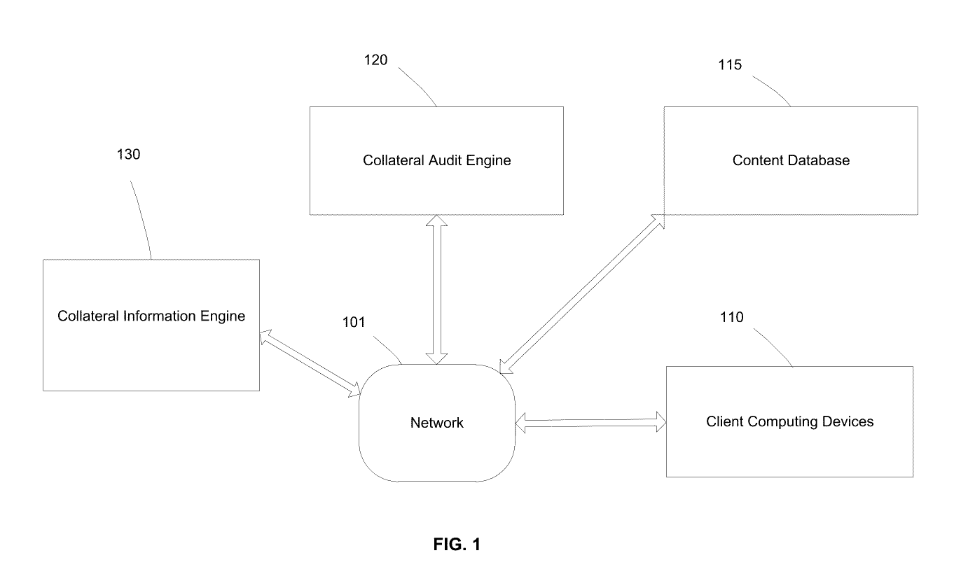

Referring initially to FIG. 1, a block diagram is illustrated of an example environment in which implementations of one or more methods related to monitoring collateral and/or mitigating risks to collateral may be implemented. The environment includes client computing devices 110, content database 115, collateral audit engine 120, and collateral information engine 130. The environment also includes a communication network 101 that enables communication between various components of the environment.

The collateral information engine 130 may analyze data related to collateral and provide action notifications concerning the collateral according to aspects of one or more implementations of methods described herein to mitigate risks to the collateral. The collateral information engine 130 may perform one or more of the steps of the methods described herein. The collateral information engine 130 may be implemented in hardware, firmware, and/or software running on hardware. For example, the collateral information engine 130 may be implemented in one or more computer servers and/or one or more client computing devices. The collateral information engine 130 may optionally contain one or more modules to perform different tasks within the collateral information engine 130. For example, a collateral navigation module may implement a graphical user interface to enable navigation of the collateral data; a risk analysis module may aggregate data to determine the risk associated with a property; and/or a collateral analysis module may determine the actions items to process and/or determine the triggers associated with those action items. The collateral information engine 130 is described in more detail herein with reference to additional Figures herein.

The data related to collateral that is processed by the collateral information engine 130 may be data that is generated via on-site analysis of the collateral. For example, the data may be generated via input entered by a user into a collateral audit engine 120. In some implementations the collateral audit engine 120 may include a computing device such as, for example, a tablet computing device and/or a smartphone. The collateral audit engine 120 includes memory for storage of data and software applications, a processor for accessing data and executing applications, and components the facilitate communication over a communication network 101. The collateral audit engine 120 executes one or more applications that enable the user to input data related to collateral and submit the data to the collateral information engine 130. The user may submit the data to the collateral information engine 130 either directly or indirectly. For example, the data may be sent from the collateral audit engine 120 to the content database 115 via network 101, then the collateral information engine 130 may access the data from the content database via network 101. The collateral audit engine 120 may enable input of data related to collateral according to aspects of one or more implementations of methods described herein. The collateral audit engine 120 may perform one or more of the steps to prompt a user and/or enable a user to enter data pertinent to the collateral such as one or more steps of certain methods described herein.

The communication network 101 facilitates communication between the various components in the environment. In some implementations the communication network 101 may include the Internet, one or more intranets, and/or one or more bus subsystems. The communication network 101 may optionally utilize one or more standard communications technologies, protocols, and/or inter-process communication techniques.

Many other configurations are possible having more or less components than the environment shown in FIG. 1. For example, although the collateral audit engine 120 is illustrated as a single component in FIG. 1, it is understood that the collateral audit engine 120 may optionally incorporate multiple computing devices in some implementations (e.g., a tablet computer, a smartphone, a desktop computer, and/or a server working in cooperation).

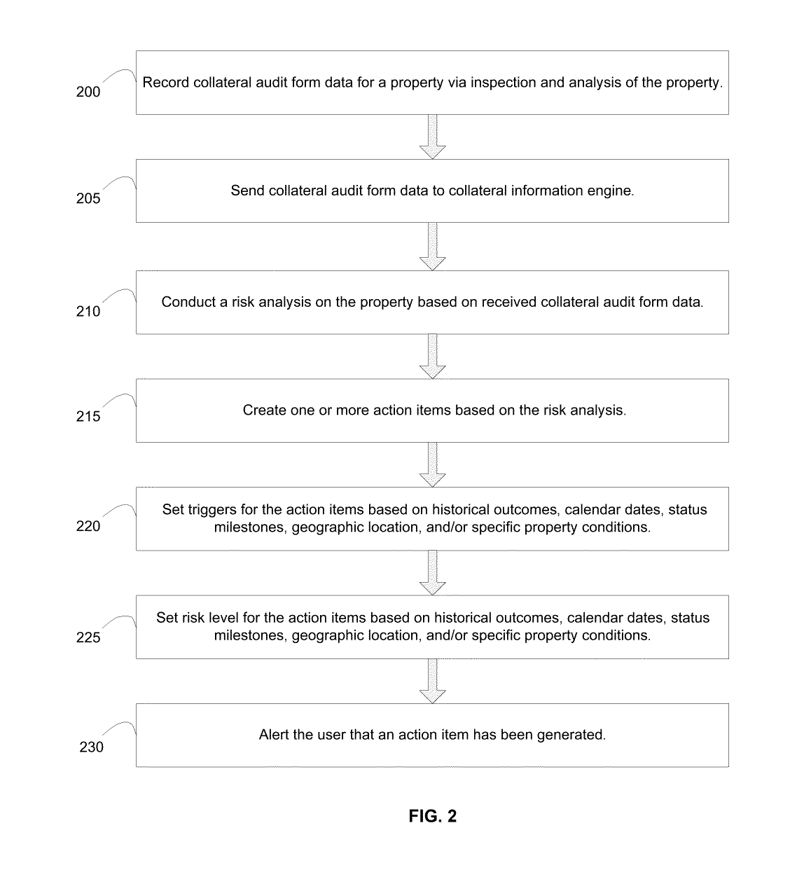

Referring to FIG. 2, a flow chart illustrating steps of an implementation of a method of analysis and maintenance of collateral is illustrated. Other implementations may perform the steps in a different order, omit certain steps, and/or perform different and/or additional steps than those illustrated in FIG. 2. For convenience, aspects of FIG. 2 will be described with reference to a system of one or more computers that perform the process. In some implementations the system may include, for example, the collateral information engine 130. In some implementations the system may additionally or alternatively include any number of client computing devices 110 of FIG. 1. In some implementations the system may additionally or alternatively include any number of collateral audit engines 120 of FIG. 1.

At step 200, collateral audit form data for a property is recorded. The collateral audit form data may be collected via inspection and/or analysis of the property. Examples of collateral audit form data include a property's occupancy, operations, utilities, physical condition, security, environmental risks, waste storage and disposal, legal exposures, and/or neighborhood setting.

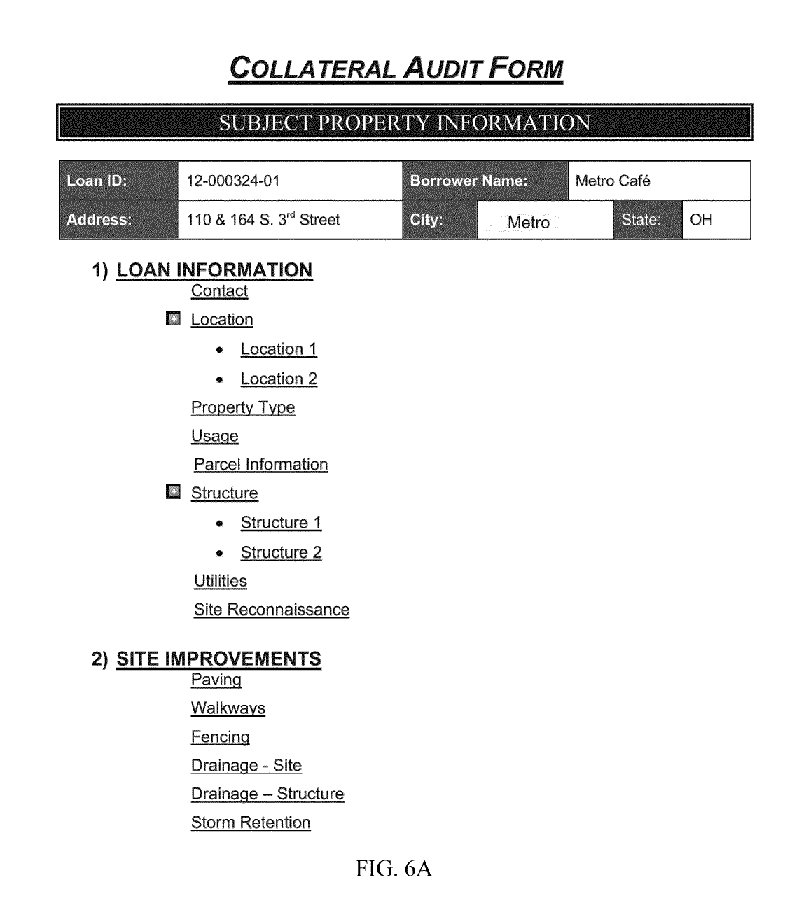

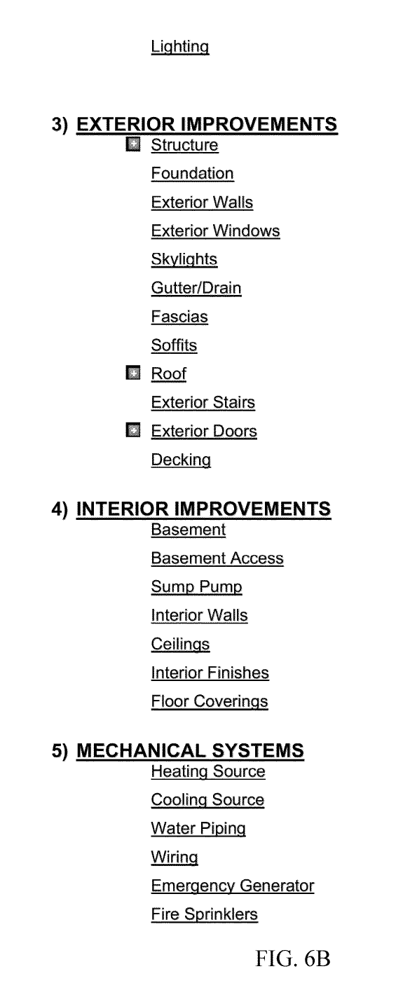

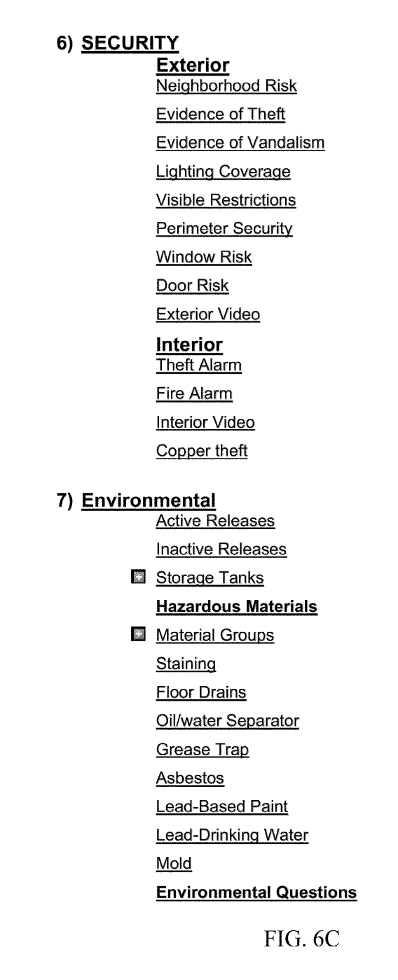

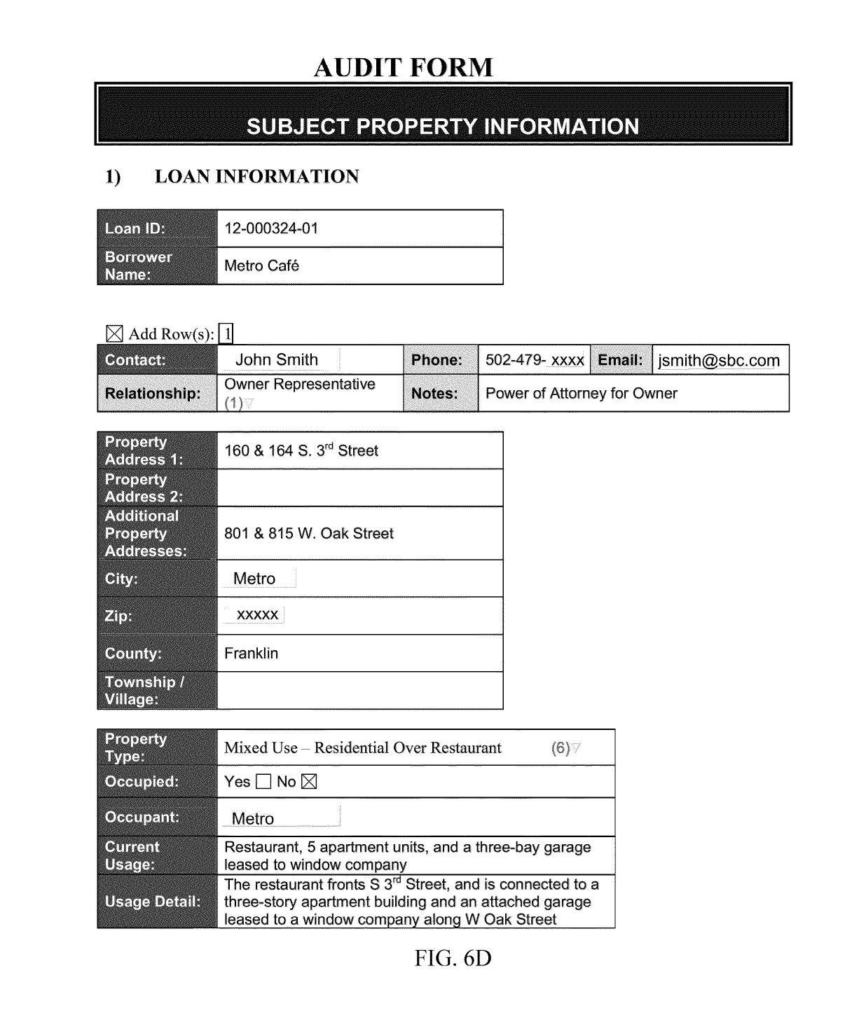

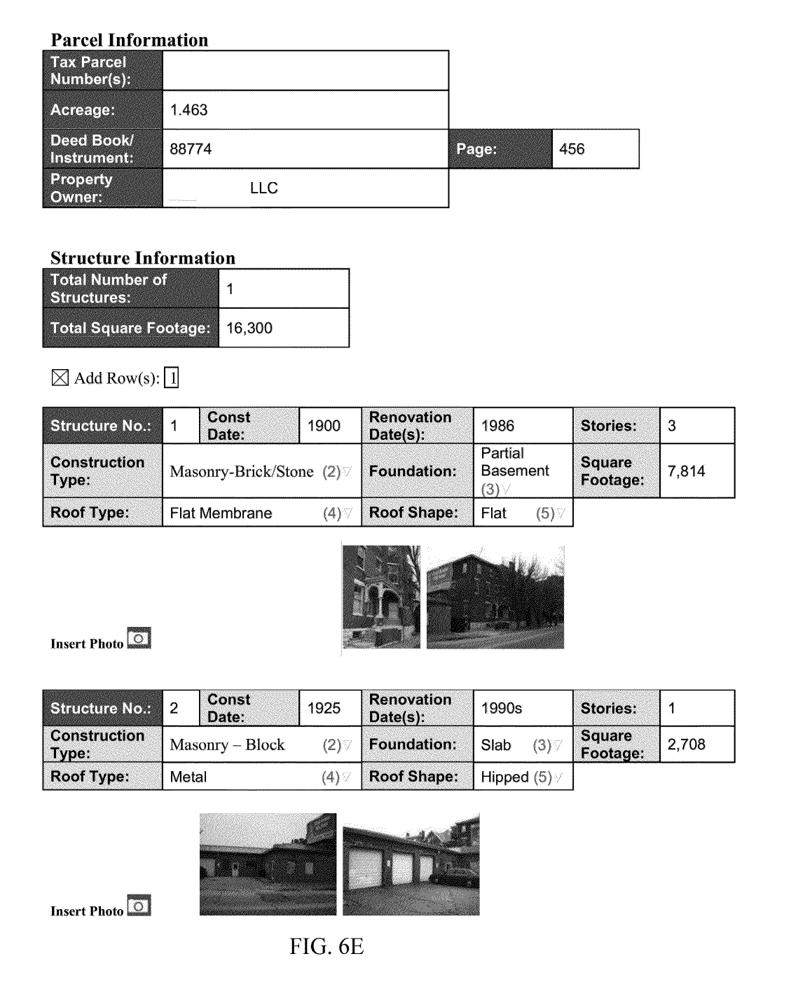

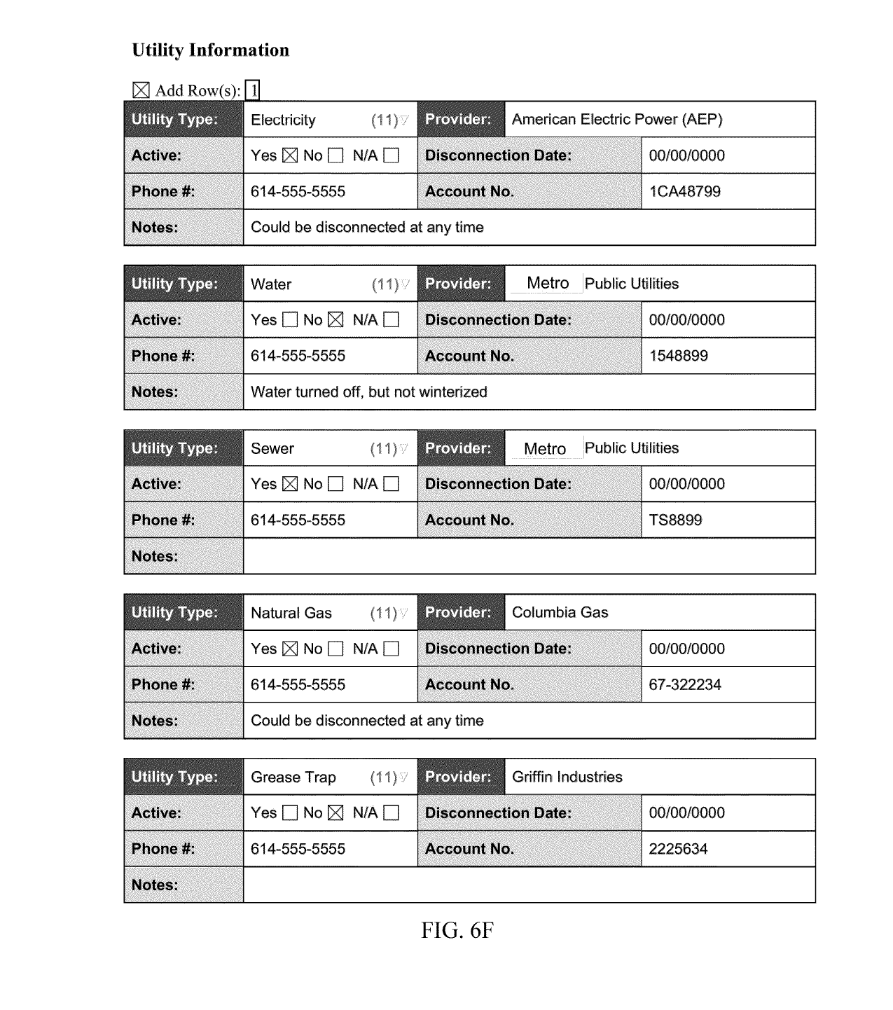

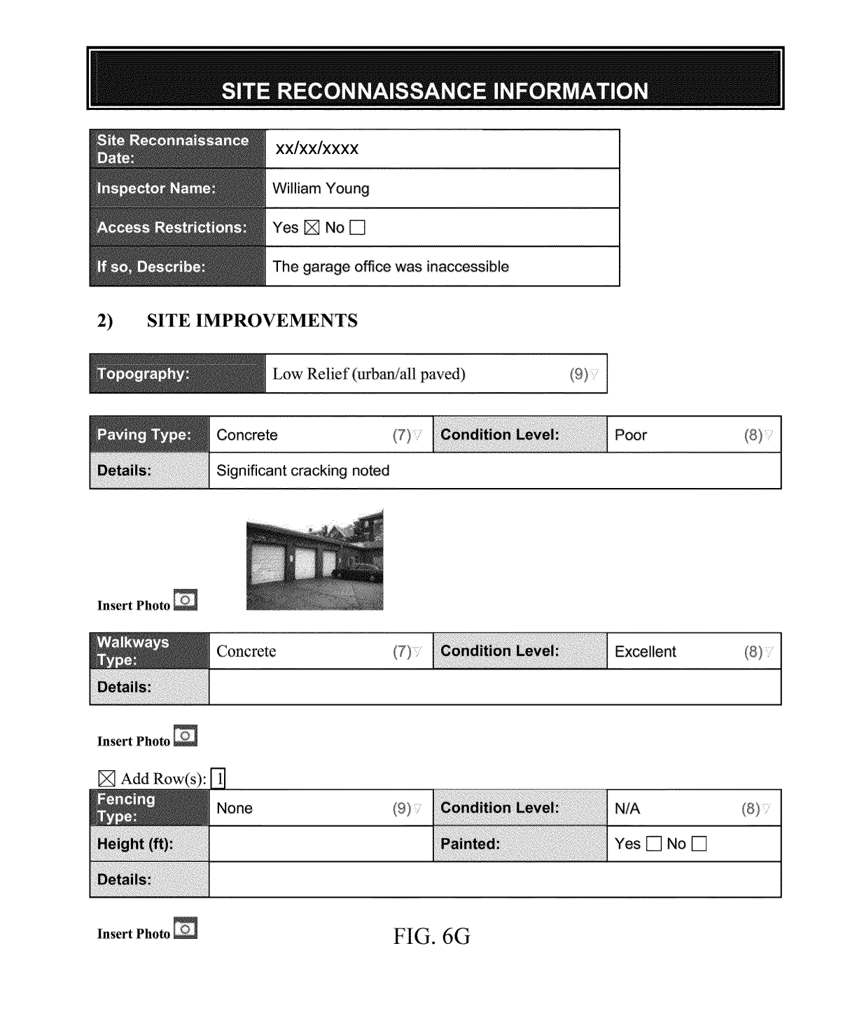

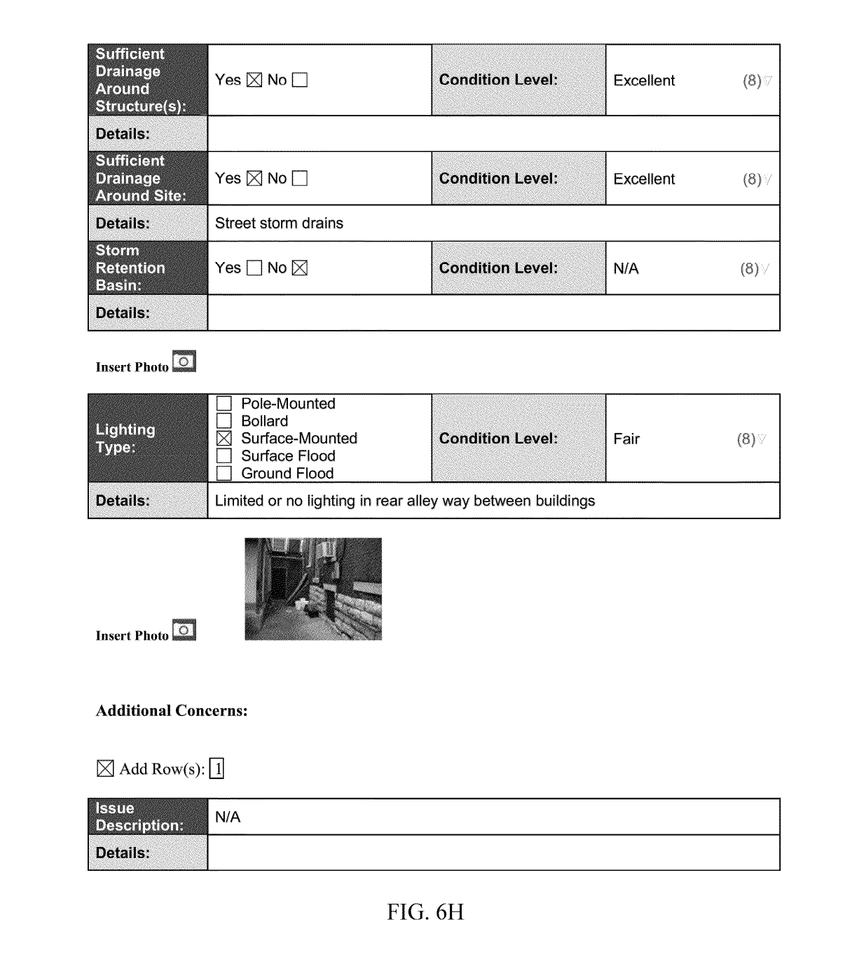

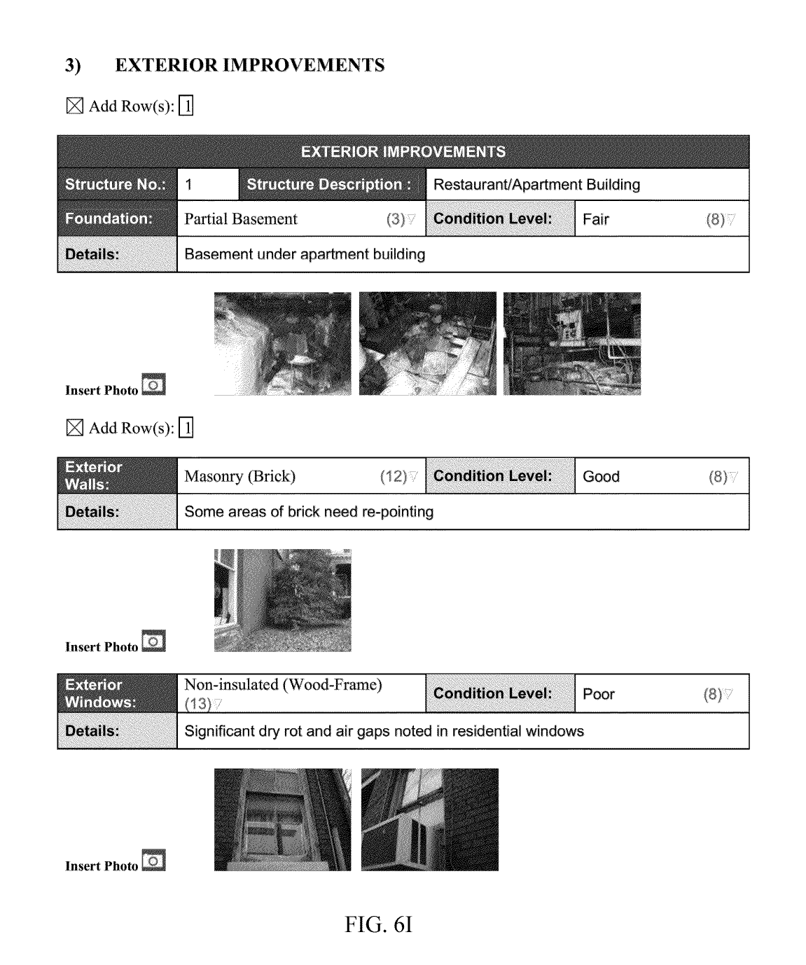

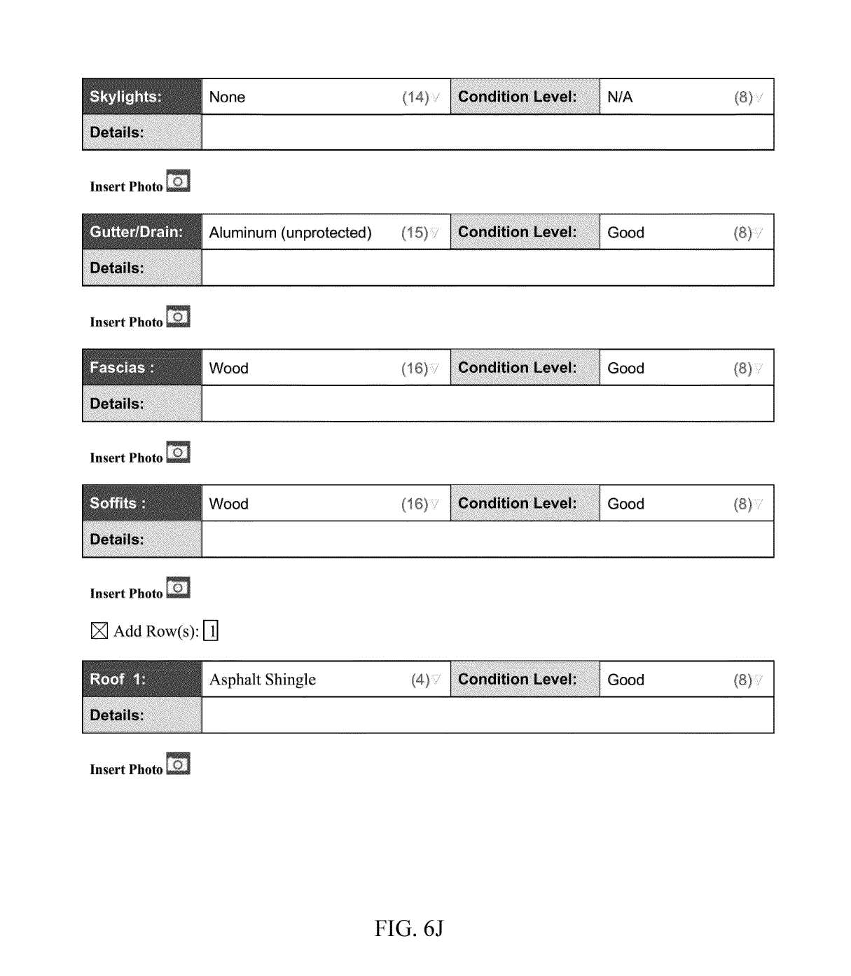

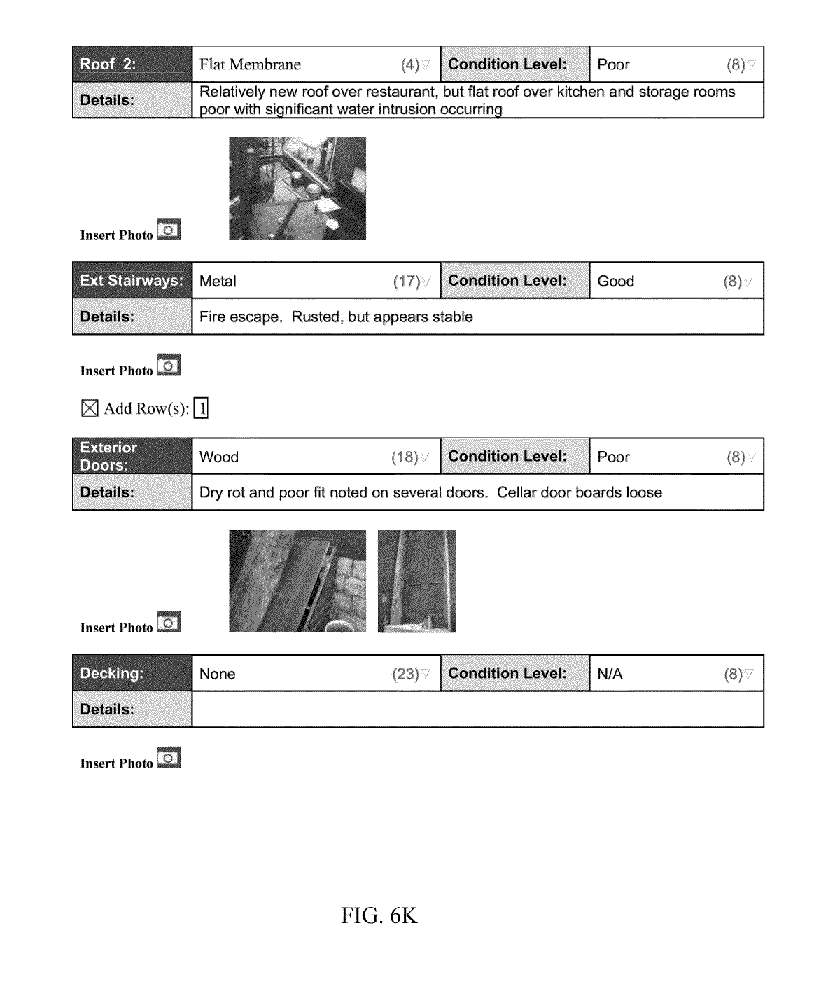

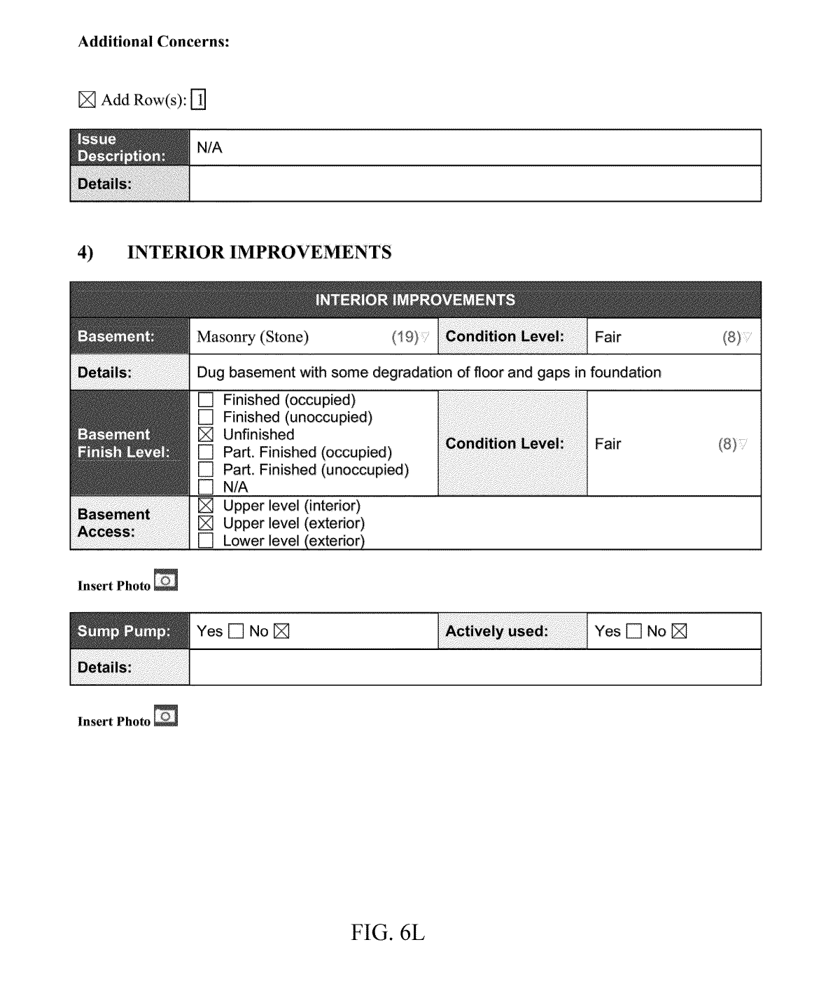

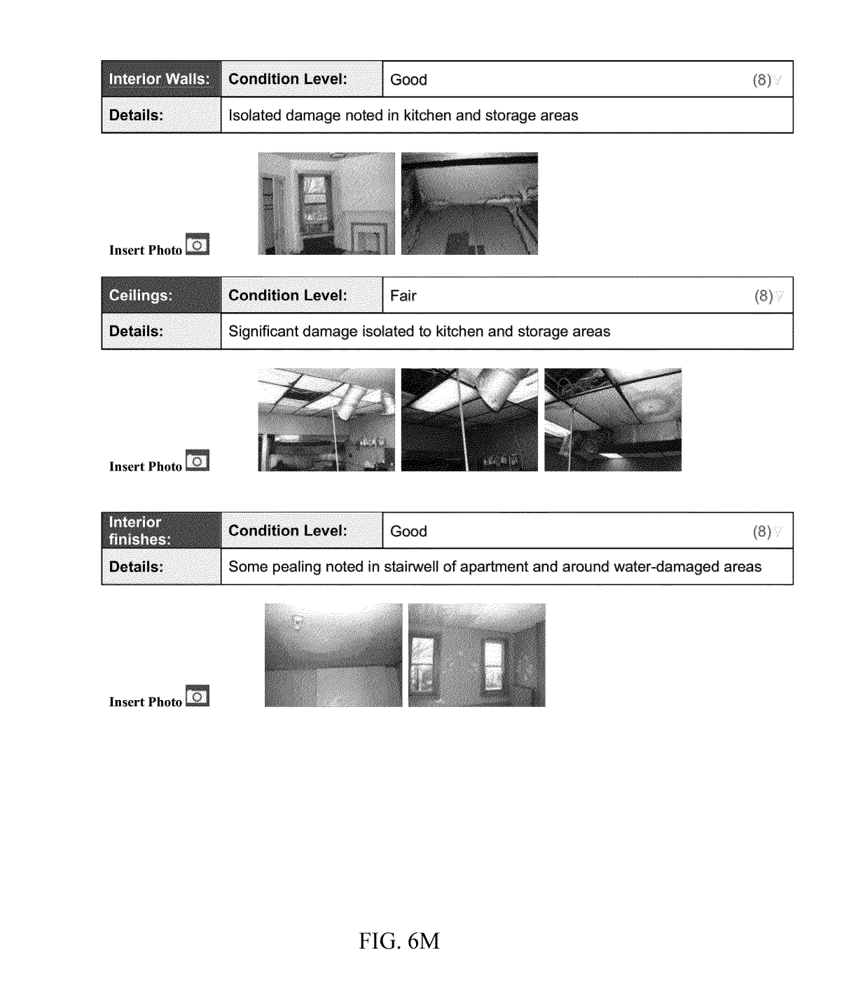

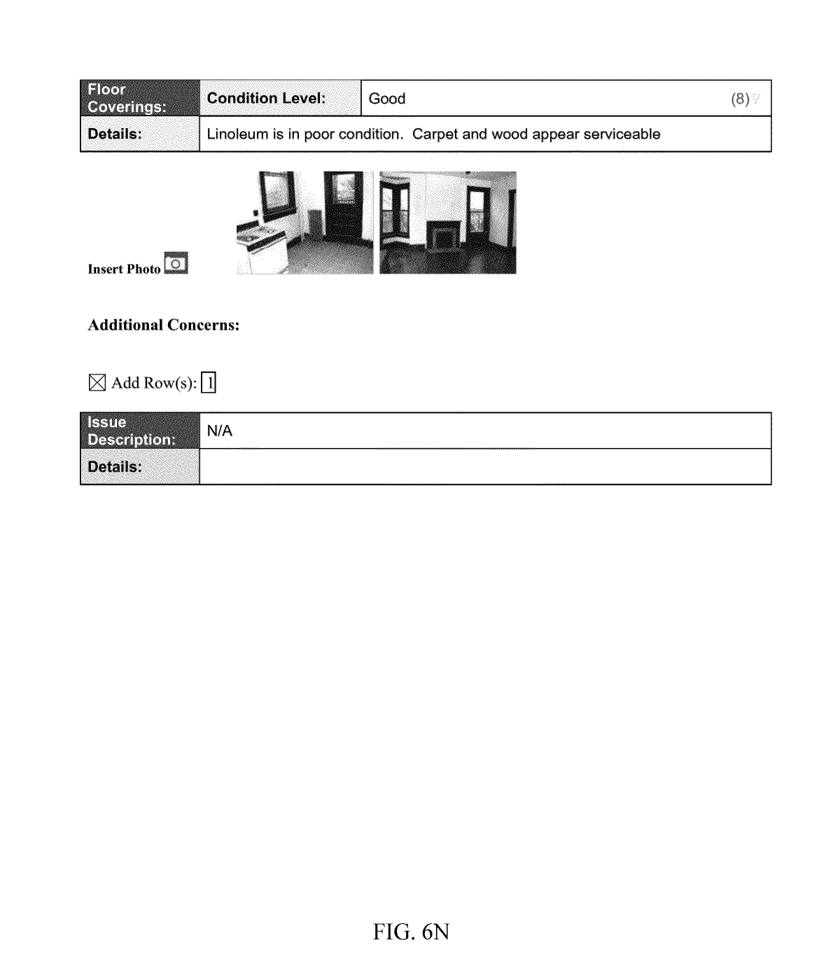

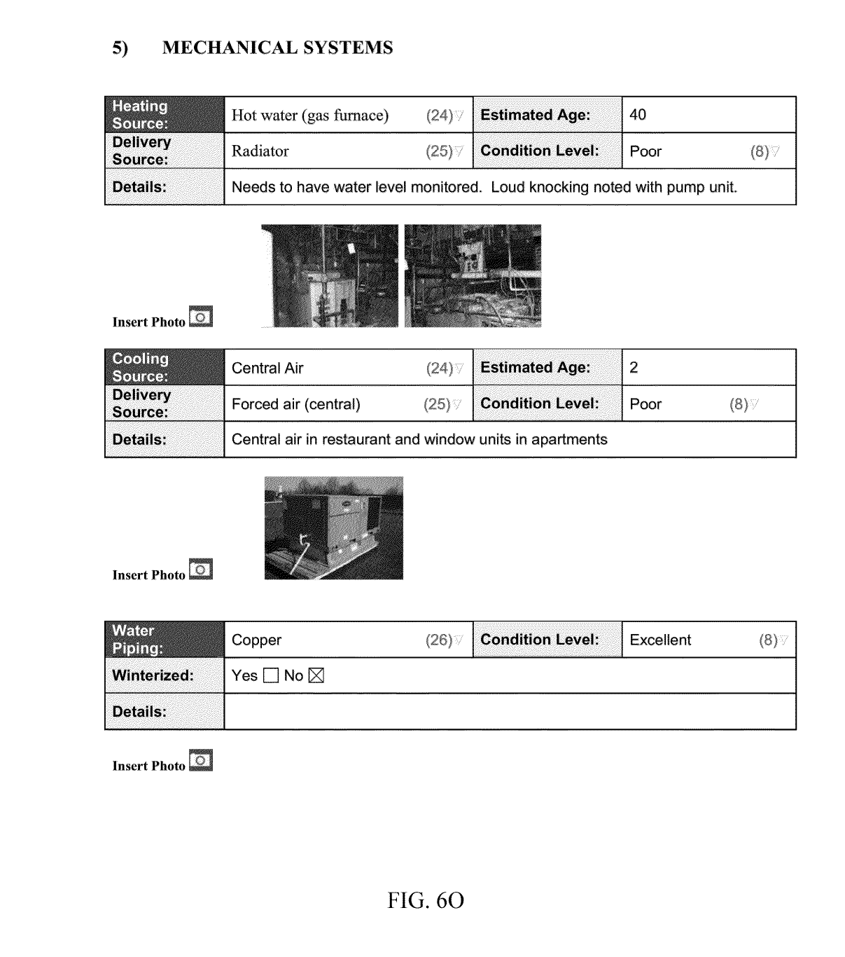

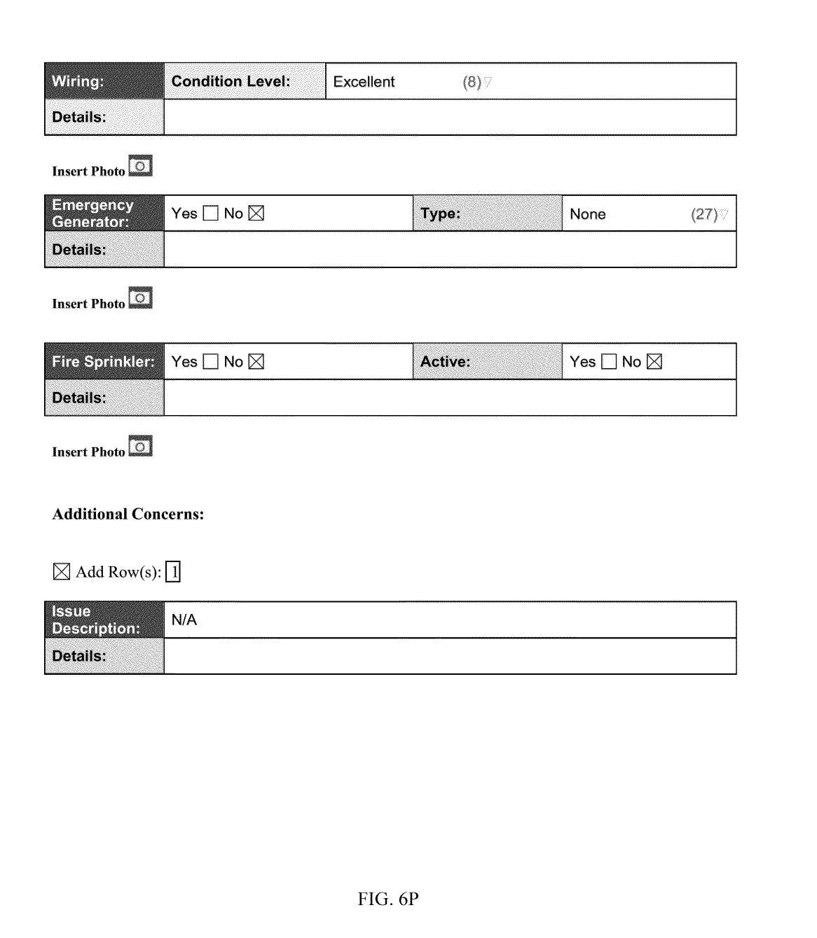

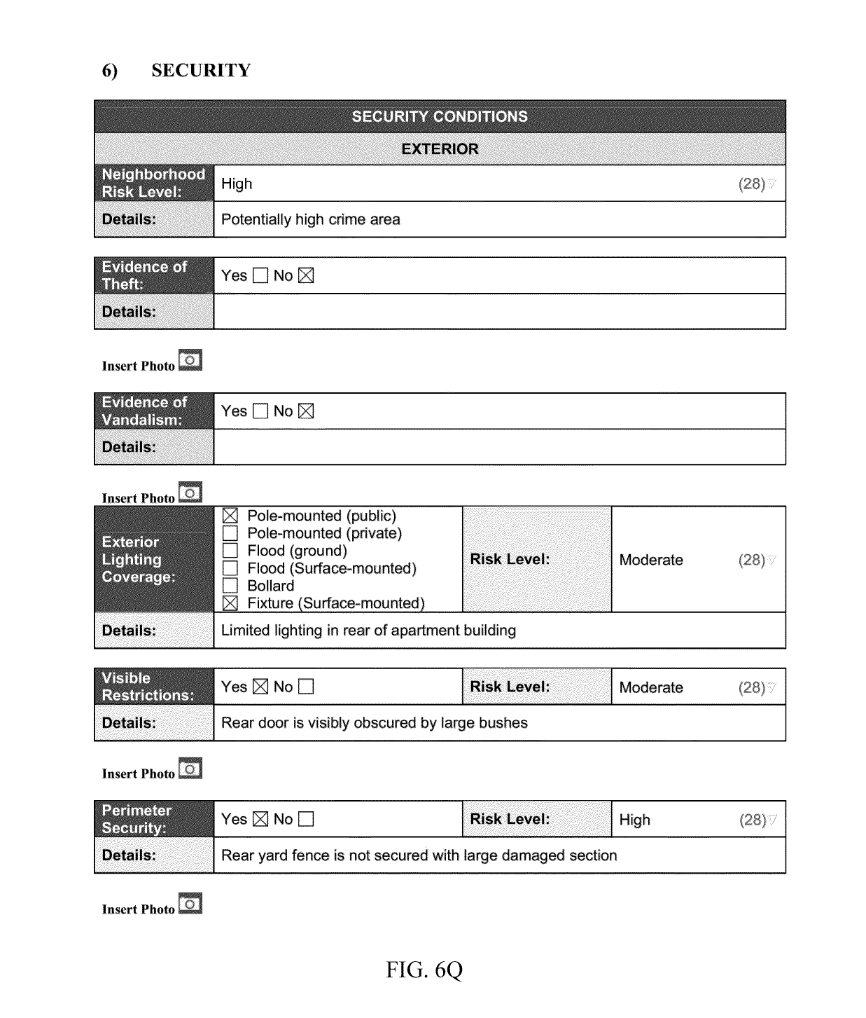

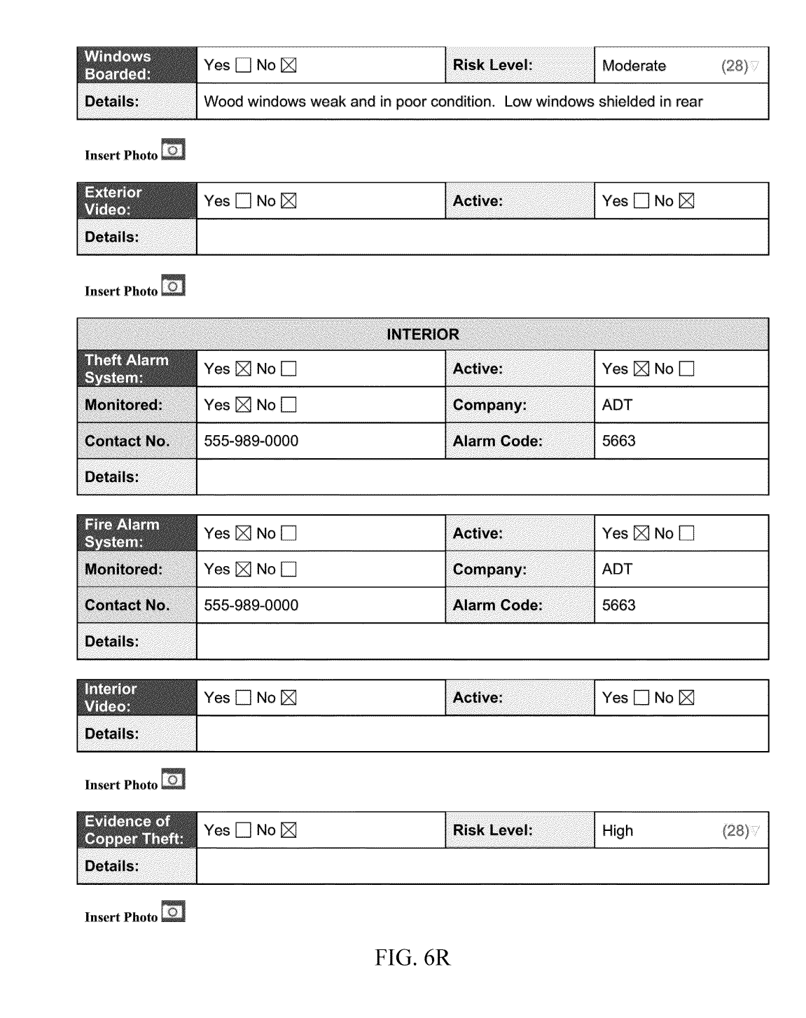

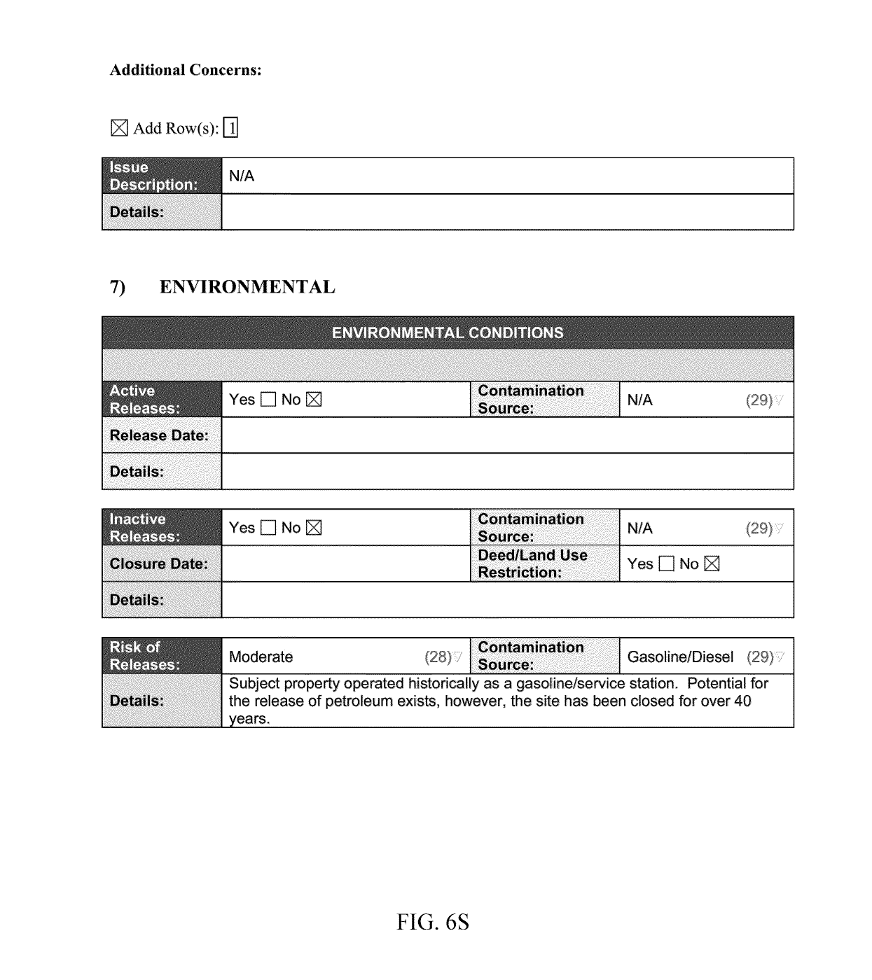

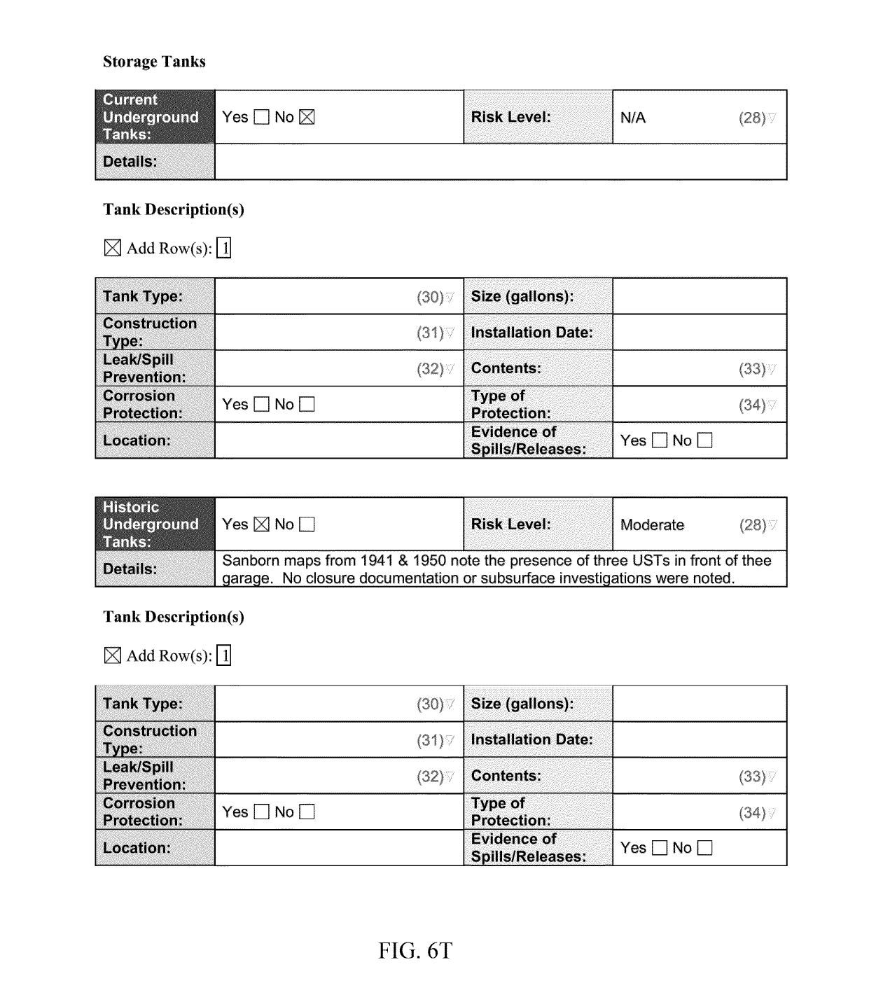

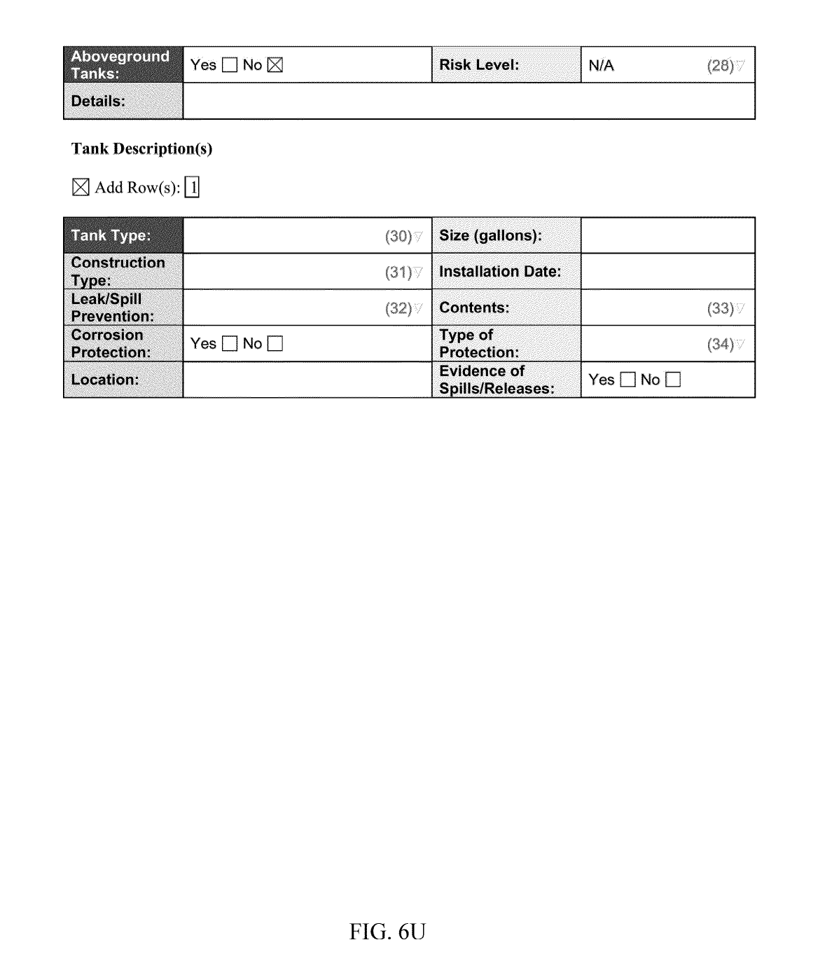

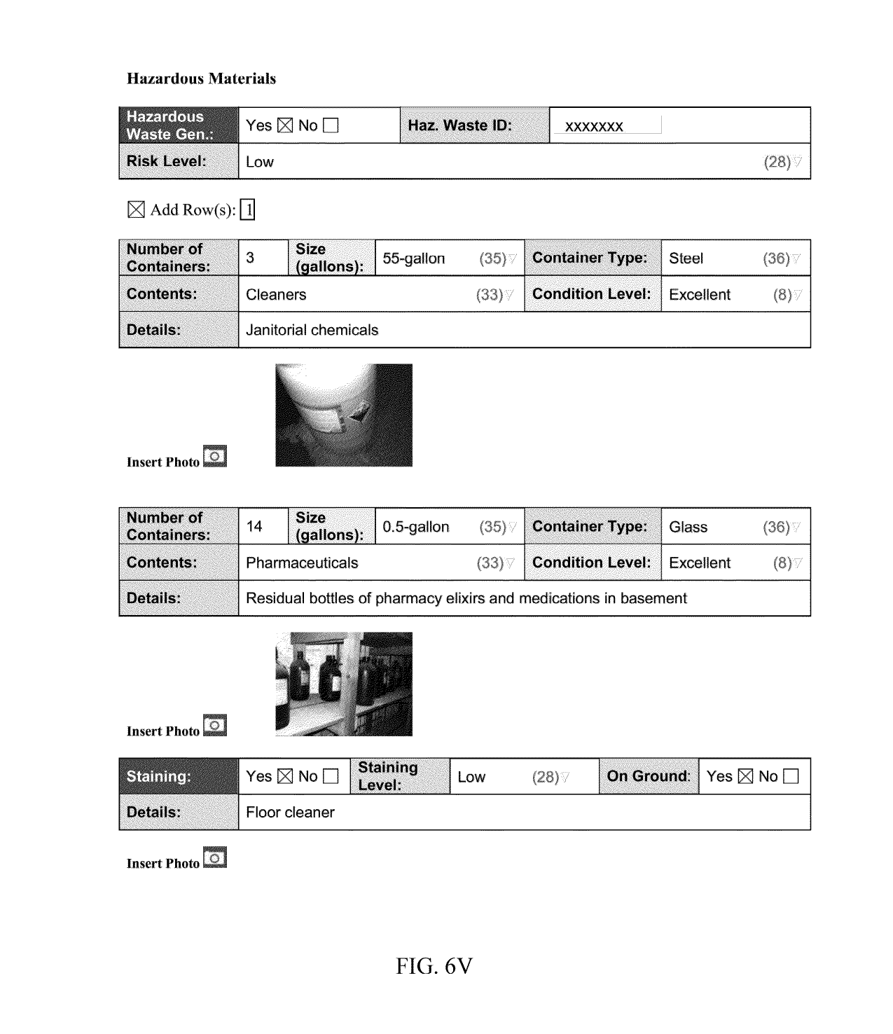

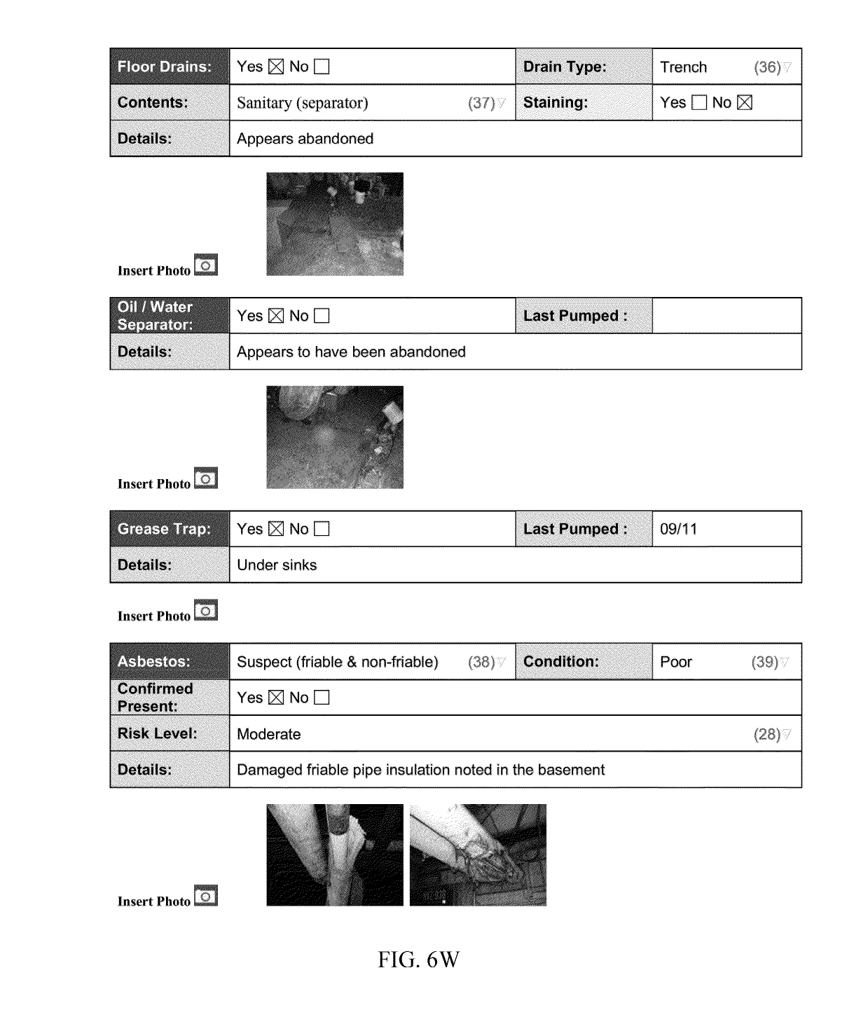

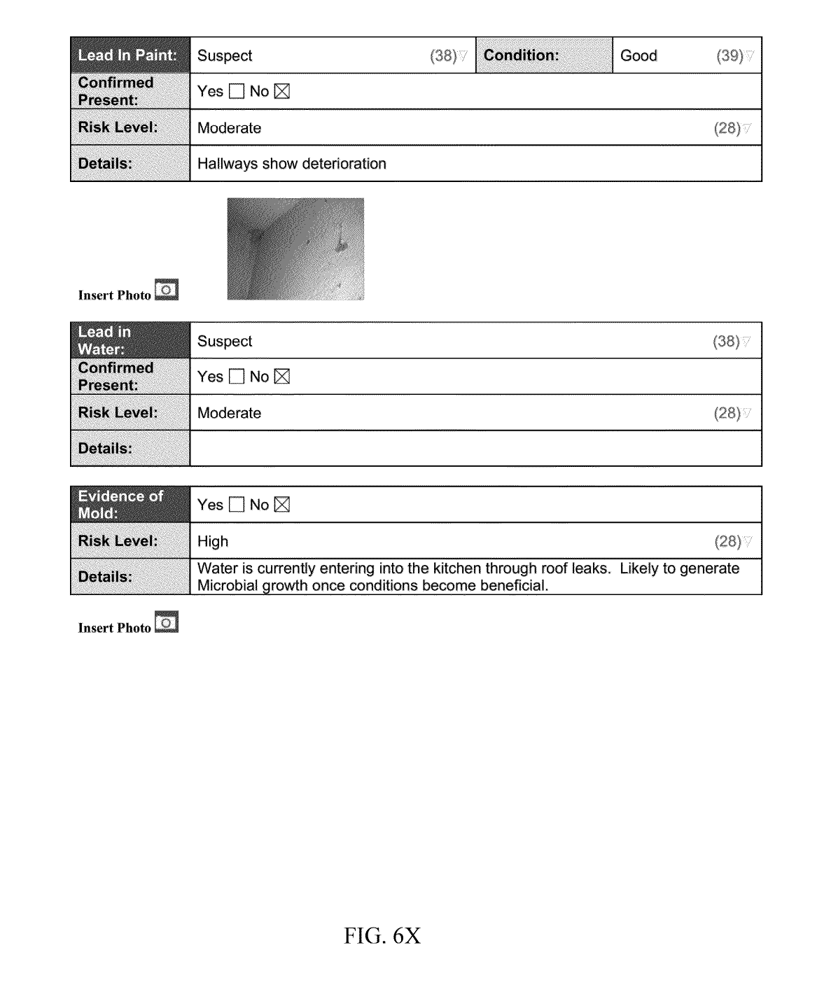

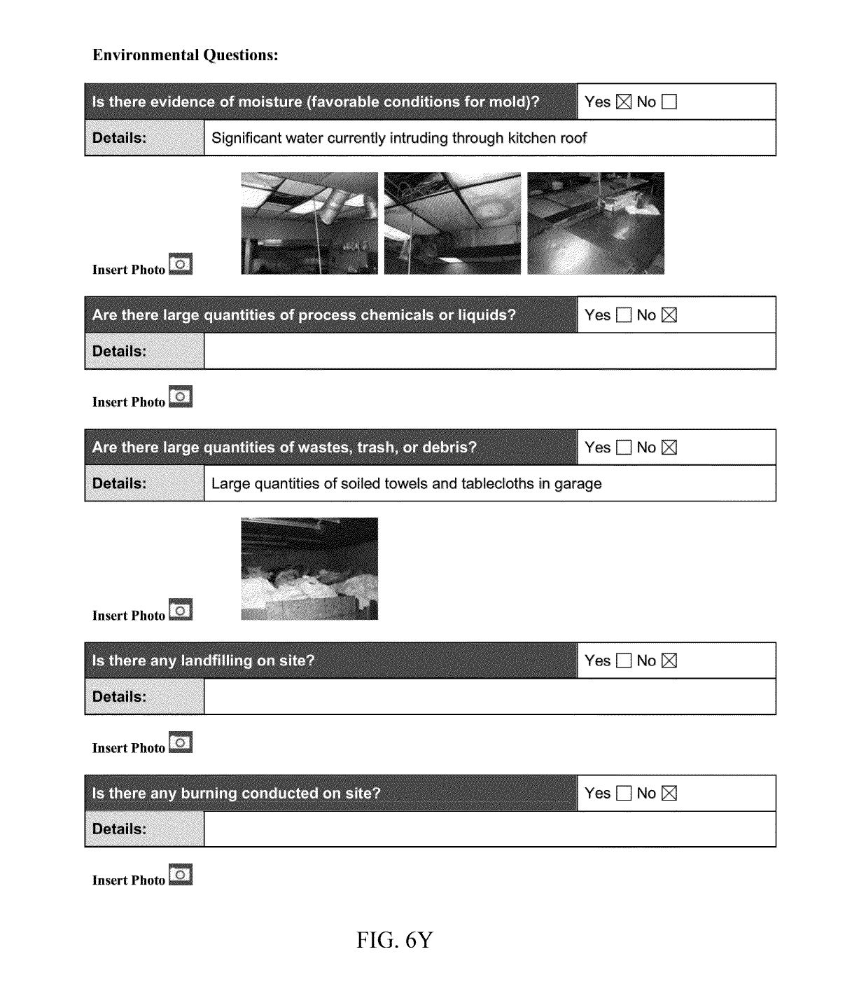

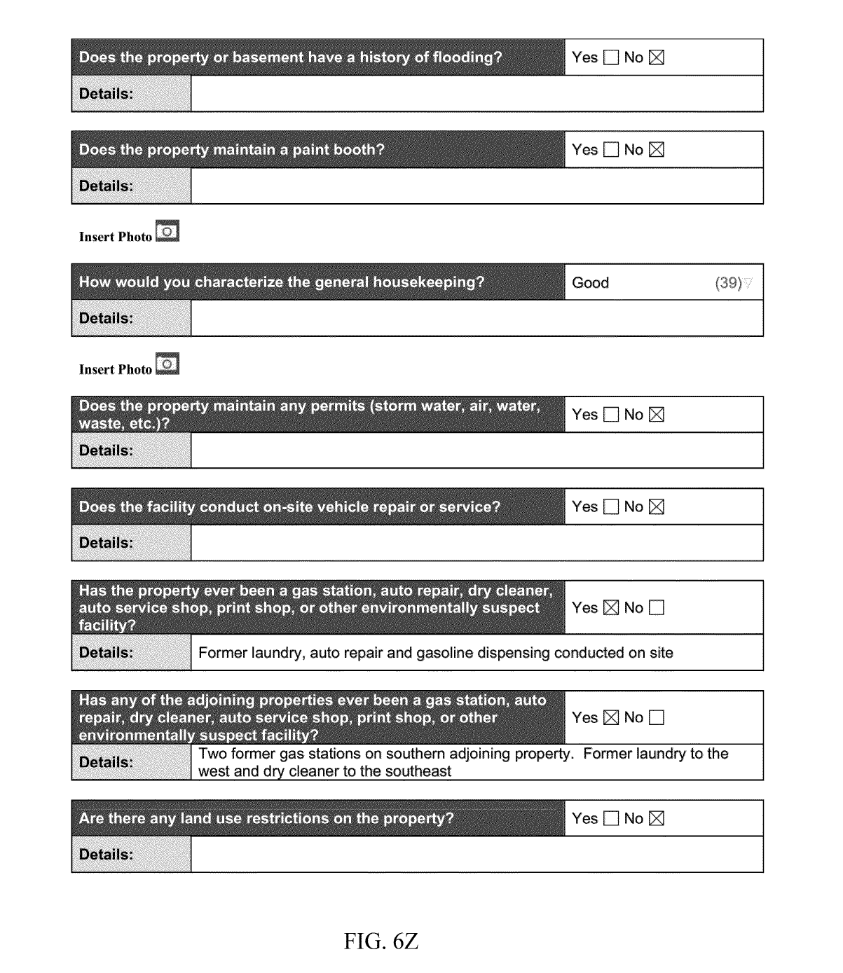

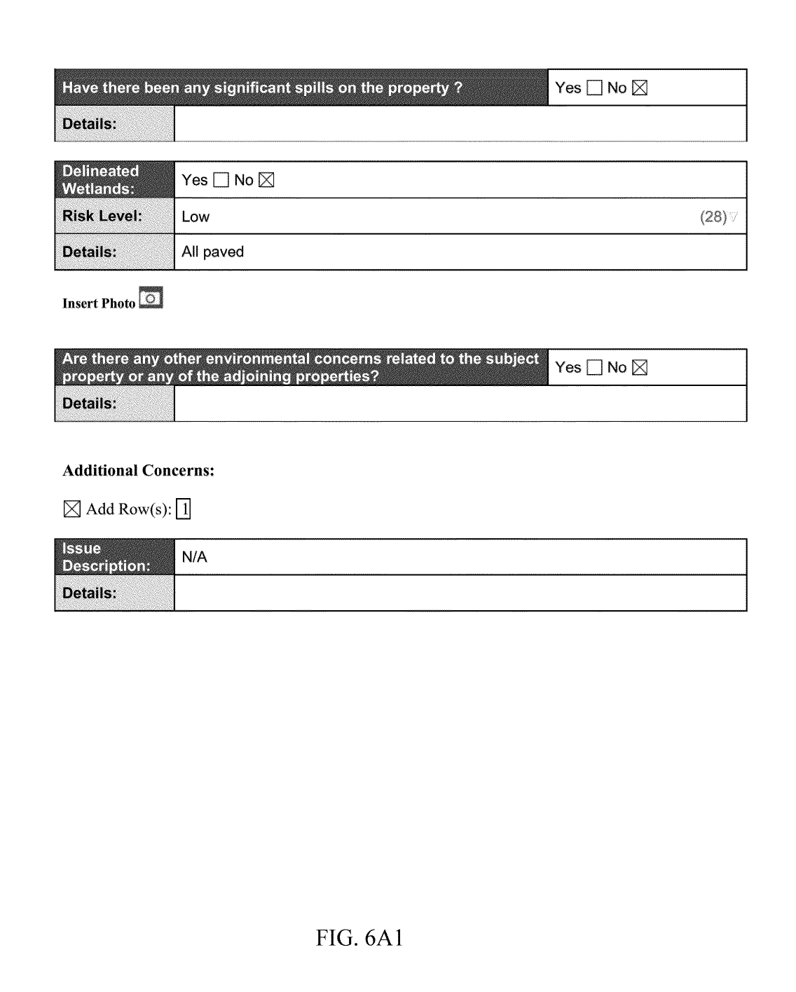

In some implementations, the collateral audit form data may be recorded via the collateral audit engine 120. An inspector may investigate the collateral and populate fields of a collateral audit form based on observations of the collateral to thereby generate collateral audit form data. An example of a collateral audit form is provided in FIGS. 6A-6A1 and discussed in detail herein.

At step 205, collateral audit form data is sent to the collateral information engine 130. In some implementations the collateral audit form data may be immediately transmitted to the collateral Information engine 130 from the collateral audit engine 120 through communications network 101. In some implementations the collateral audit form data may be locally stored on the collateral audit engine 120 and/or the content database 115 for later transmission to the collateral information engine 130, either through a direct connection or via the network 101.

At step 210, a risk analysis is conducted on the property based on received collateral audit form data. The risk analysis may be conducted by the collateral information engine 130 and/or a user. In some implementations the collateral information engine 130 may take into account the recorded collateral audit form data such as a property's occupancy, operations, utilities, physical condition, and/or environmental risks when conducting a risk analysis. For example, the risk analysis may be performed based on collateral audit form data for an unoccupied building in a northern latitude. Based on the collateral audit form data (e.g., water status, winterization status, and/or geographic location), the property may be red-flagged for winterization of water piping and/or other issues.

At step 215, the collateral information engine 130 creates an action item based on the risk analysis performed at step 210. The action item indicates that an action may be required based on the collected collateral audit form data at step 200 and the risk analysis conducted at step 210. In some implementations the collateral information engine 130 may create action items for boiler maintenance, pipe winterization, and/or roof repairs. For example, the collateral audit form data that was collected at step 200 may indicate that the water has not been shut off to a property, the geographic location of the property has subzero temperatures in the winter, and that the property is currently unoccupied. Based on such data, an action item may be generated for the property that indicates that the building will need to be winterized in order to prevent possible damage in the future. Action items may additionally or alternatively be generated based on a status milestone (e.g., foreclosure, vacancy, and/or property disposition) and/or legal procedure (e.g., ejectment notice and/or grant of right to enter the property).

At step 220, a trigger is set for the action item generated at step 215. The trigger indicates an event that, once it occurs, will activate the action item. A trigger may be set, for example, based on historical outcomes, calendar dates, status milestones, geographic location, specific property conditions, and/or manual user input. For example, in some implementations a trigger may be set for an action item indicating that a building will need to be winterized to avoid possible water pipe damage. The trigger may be a calendar date that is prior to likely freezing weather based on the geographic location. Another trigger may optionally be set for a later date in the event that the action item has not been addressed at that time.

At step 225, a risk level is assigned to the action items generated at step 215 based on historical outcomes, calendar dates, status milestones, geographic location, and/or specific conditions. The risk level provides an indication of the urgency of the action item and/or the severity of the consequences if the action item is not performed. For example, an action item may be characterized as high risk if failure to perform the action item may result in significant damage to the collateral at a later date. For example, in some implementations, an action item to winterize a building's water pipes may have a low risk level when the trigger for that action item is activated on a date prior to possible freezing weather because the likelihood of damage at that time is minimal. The risk level may be upgraded to a high alert at a later date to indicate that the possibility of freezing weather is more likely and there is a greater risk of property damage if the water pipes are not winterized. In some implementations a risk level may be generated automatically by the collateral information engine 130 based on historical data. For example, in some implementations historical data for a given geographic location may indicate that the risk of vandalism to a vacant property is high so an action item to increase security on the property is given a high risk level. In some implementations the risk level may be set and/or manually altered by a user. In some implementations the risk level of an action item may be stored in a content database 115 for retrieval at a later time.

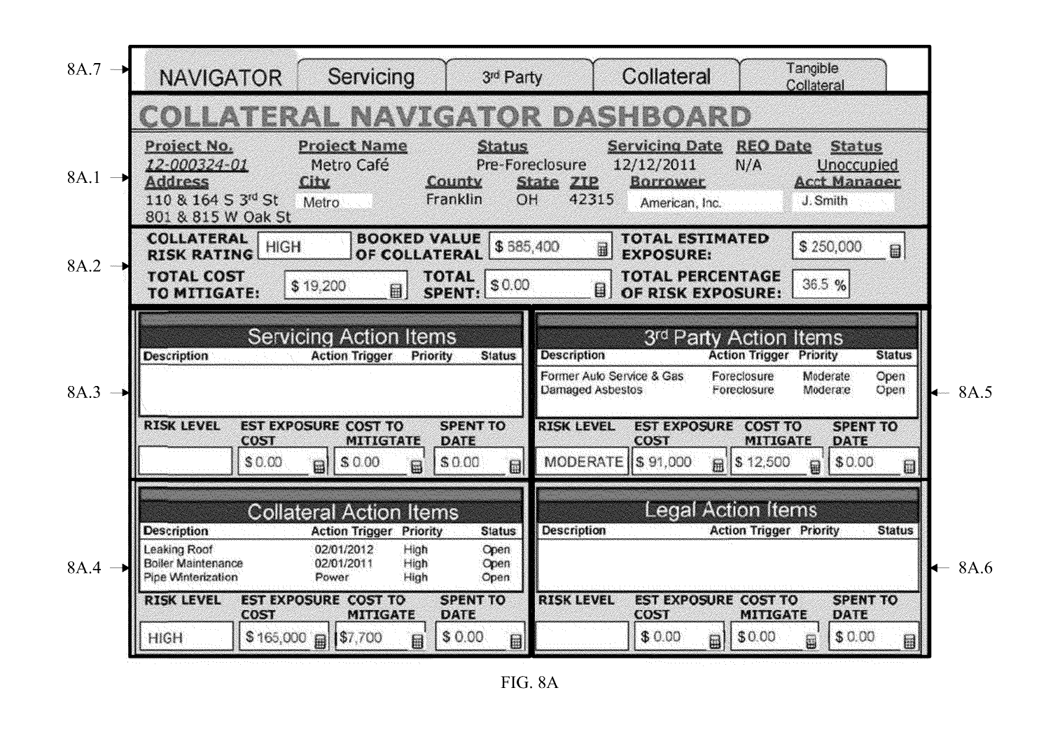

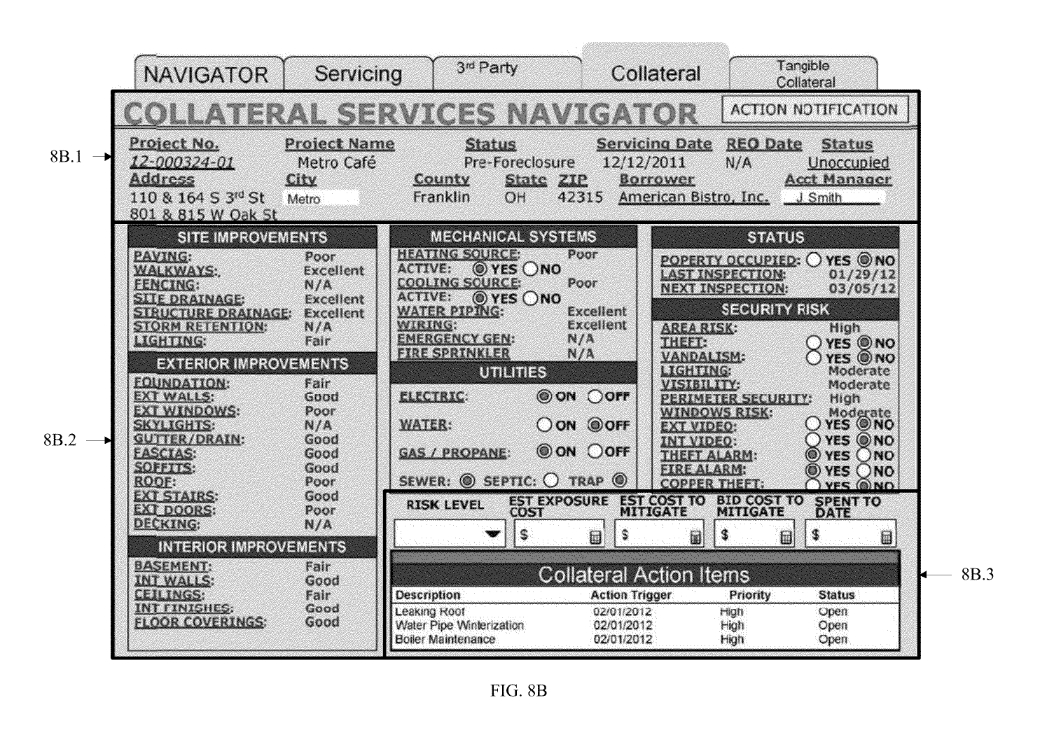

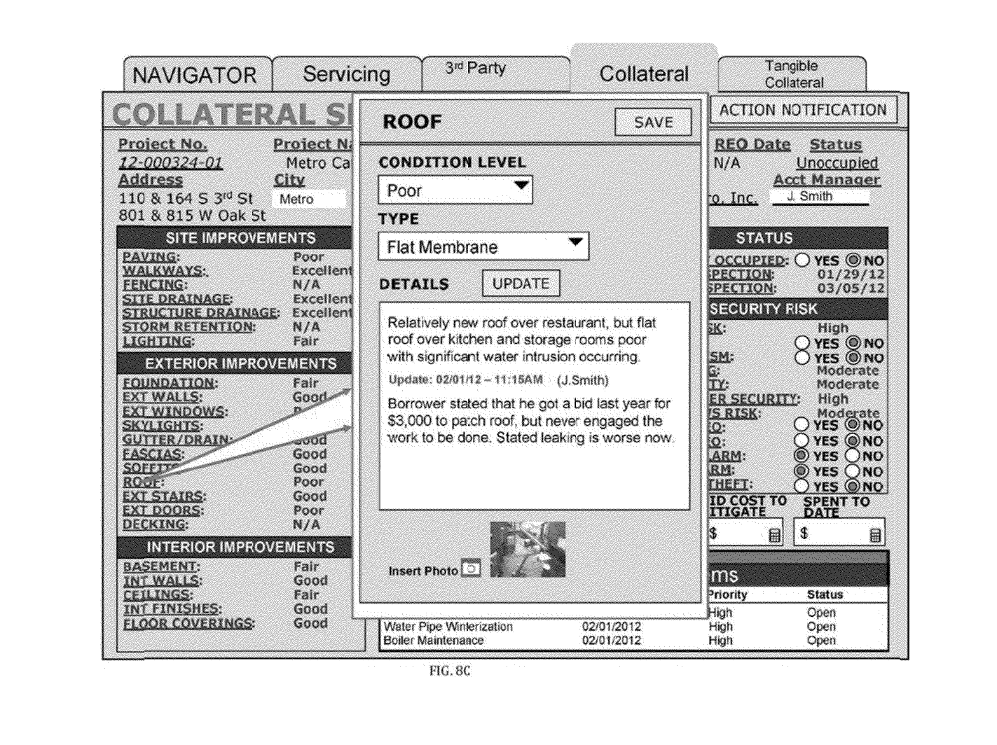

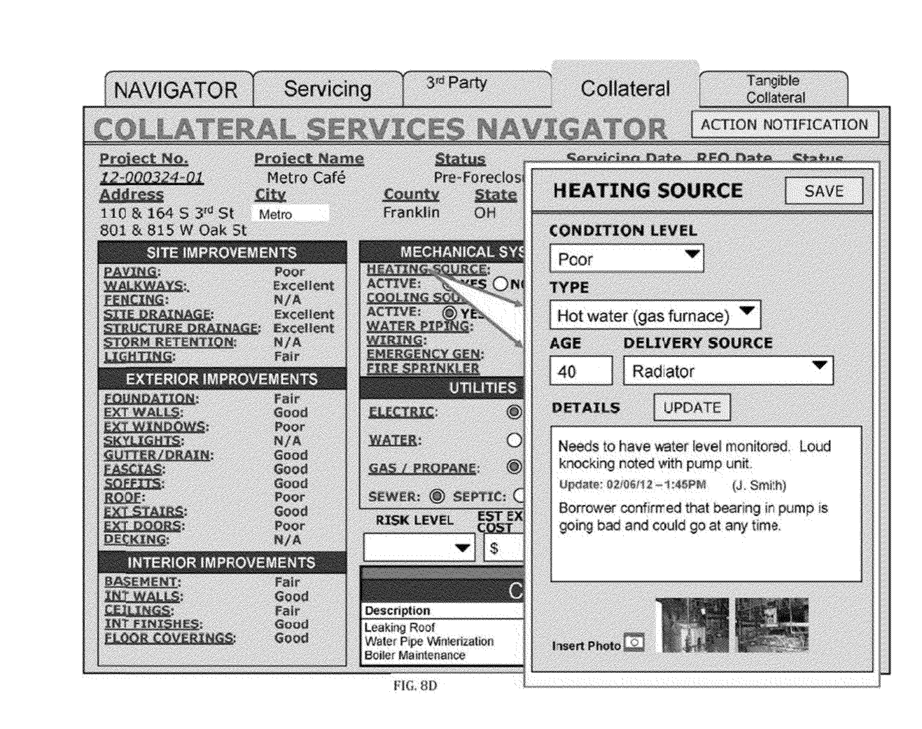

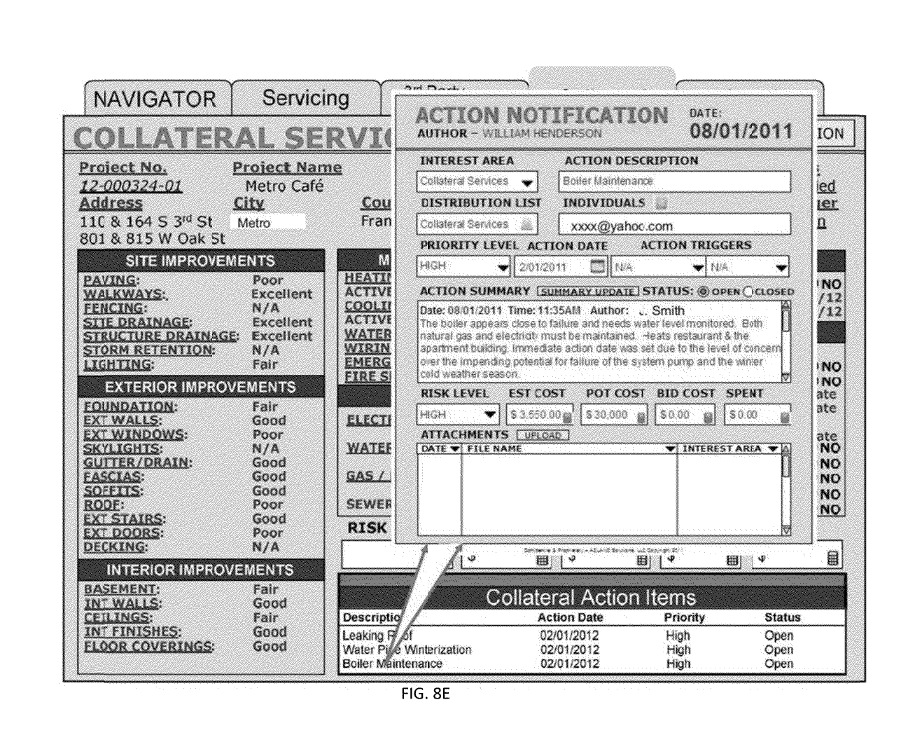

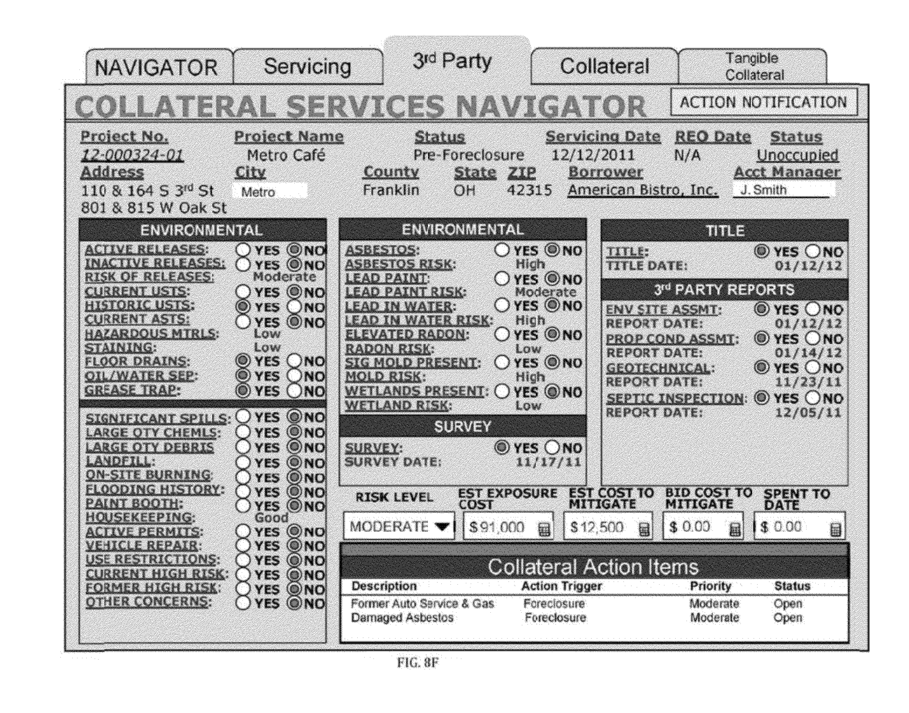

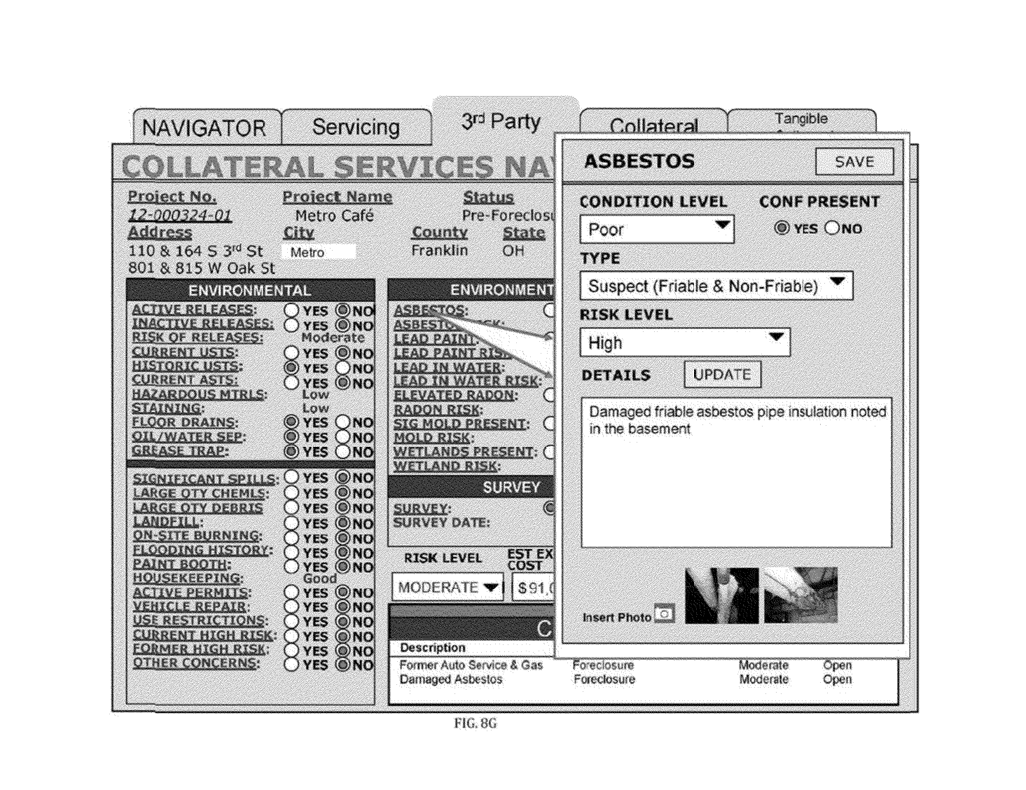

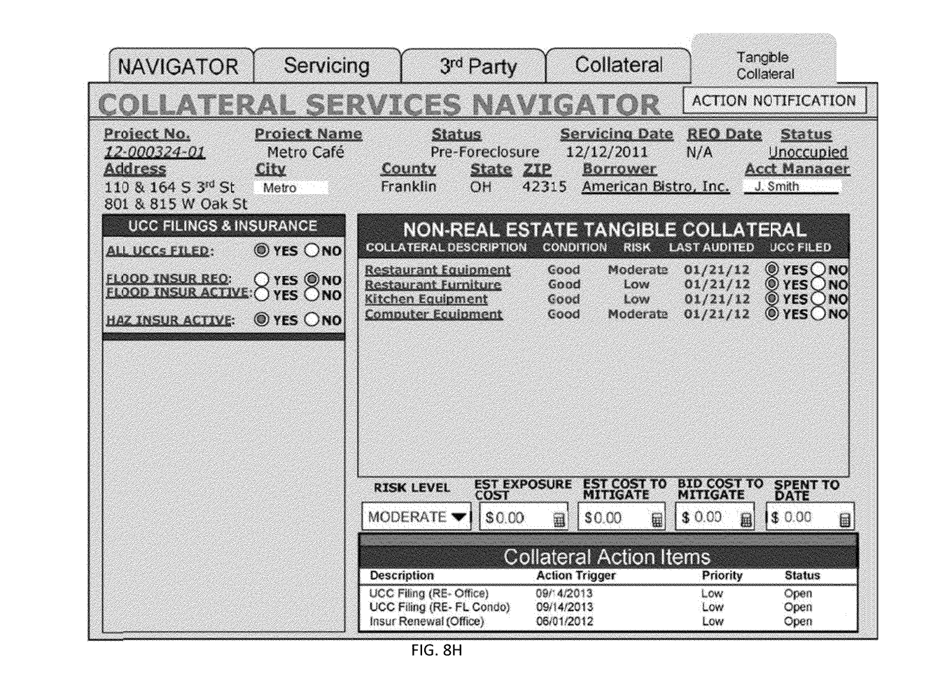

At step 230, the user is alerted to the generation of an action item and/or the change in the status of an action item. In some implementations the alert may be conveyed to a client computing device 110 for display to the user via a user interface similar to the user interfaces exemplified in FIGS. 8A-8H. In some implementations the user may be alerted through an automatically generated email.

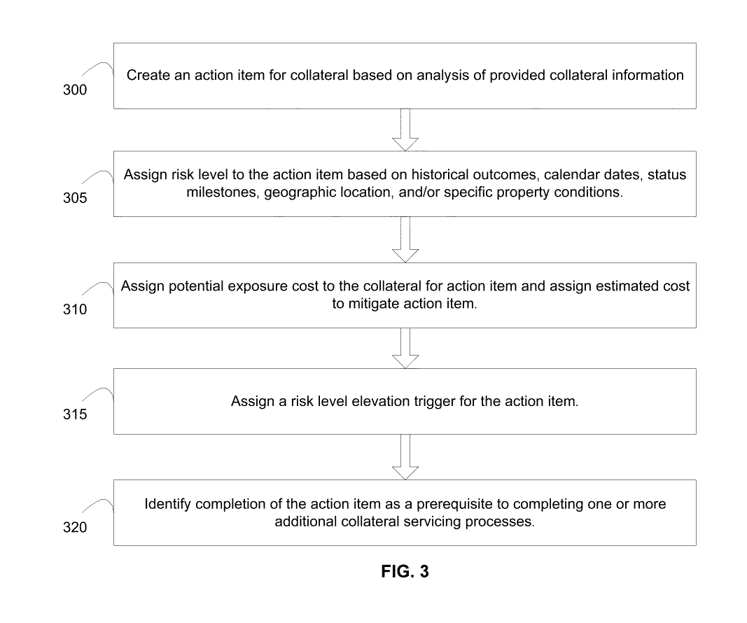

Referring to FIG. 3, a flow chart illustrates the steps of another implementation of a method of analysis and maintenance of collateral. Other implementations may perform the steps in a different order, omit certain steps, and/or perform different and/or additional steps than those illustrated in FIG. 3. For convenience, aspects of FIG. 3 will be described with reference to a system of one or more computers that perform the process. In some implementations the system may include, for example, the collateral audit engine 120 of FIG. 3. In some implementations the system may additionally or alternatively include any number of client computing devices 110 of FIG. 3. In some implementations the system may additionally or alternatively include any number of collateral audit engines 120 of FIG. 1.

At step 300 an action item is created by a user and/or the collateral information engine 130 based on analysis of provided collateral information. The collateral information may be stored on a content database 115, inputted or stored on a collateral audit engine 120, and/or entered through a client computing device 110. Examples of collateral information include a property's occupancy, operations, utilities, physical condition, security, environmental risks, waste storage and disposal, legal exposures, and/or neighborhood setting. The action item indicates that an action related to the collateral may be required based on the provided collateral information. In some implementations the collateral information engine 130 may create action items for boiler maintenance, pipe winterization, property security, and/or roof repairs. For example, the provided collateral information may indicate that the water has not been shut off to the property, the geographic location of the property has subzero temperatures in the winter, and that the property is currently unoccupied. An action item may be generated for the property that the building will need to be winterized in order to prevent potential damage in the future.

At step 305, a risk level is assigned to the action items generated at step 300. The risk level provides an indication of the urgency of each action item and/or the severity of the consequences if the action item is not performed. For example, an action item may be characterized as high risk if failure to perform the action item may result in significant damage to the collateral at a later date. In some implementations, an action item to winterize a building's water pipes may initially have a low risk level because the possibility of freezing weather at that time is minimal. The risk level may be upgraded to a high alert on a later date (a risk level elevation trigger for the action item), to indicate that the possibility of freezing weather is more likely and there is a greater risk of property damage if the water pipes are not winterized.

At step 310, the exposure cost and mitigation cost of the action item are assessed. Exposure cost is an estimate of the cost to repair the collateral and/or address secondary damage to the collateral if the action item is not addressed. Mitigation cost is the cost of immediately addressing the action item in order to avoid future, possibly more expensive, repairs. In some implementations mitigation costs may be calculated by computer generated estimates, submitted bids from contractors, and/or manually entered by a user. For example, an action item may be created for a building that will need to be winterized in the future. The collateral information engine 130 may use data stored in the content database 115 to estimate a cost of repair. The data in content database 115 may come from historical data, computer modeled estimates, and/or estimates based on users' input. For example, based on the available data an action item may be set to have an estimated exposure cost of $35,000, which reflects the estimated cost to fix the building if the pipes burst in the winter. Mitigation costs can be estimated based on historical data, computer modeled estimates, and/or estimates based on users' input. In some implementations the mitigation cost estimates may be replaced with a hard bid cost that was obtained via one or more submission forms from contractors. The contractors' bids may be solicited via contact from a user or the collateral information system 130 may directly contact one or more contractors via an email and/or other communication to enable bidding on the work project.

At step 315 a risk level elevation trigger is assigned to the action item. The risk level elevation trigger is set so that the risk level of the action item changes when the trigger is activated. The risk level elevation trigger increases the severity of the action item as the resolution of the action item increases in importance. In some implementations, the risk level for an action item to winterize a building may be initially set to “low” because the likelihood of freezing temperatures at that time is minimal, so the likelihood of burst pipes is also unlikely. The action item may be set with a risk level elevation trigger at a later date, which raises the risk level to “high” as an indication that the likelihood of freezing weather has increased along with a greater likelihood of bursting pipes.

At step 320, the completion of an action item may initiate one or more additional action items once the first action item is completed. In some implementations an action item may need to be completed before another process related to collateral servicing becomes available and/or may be completed. For example, in some implementations an action item may be created to indicate that a delinquency notice must be sent to a mortgagee. Before an action item to evict the occupants becomes active, the action item to issue the delinquency notice must be completed. The second action item, eviction, cannot become active until after the first action item has been completed. In some implementations a different action item may be activated after an action item has been performed. The first action item may be deactivated and/or set to indicate that the action item has been completed and one or more new action items may be created and/or the status of one or more action items may be altered to reflect that the priority for a different action item has changed. For example, an action item may indicate that a building will need to be cleaned once a month. Once the building has been cleaned and the action item is set to indicate that the action item has been completed, a new action item may be activated to indicate that the building will need to be cleaned the next month.

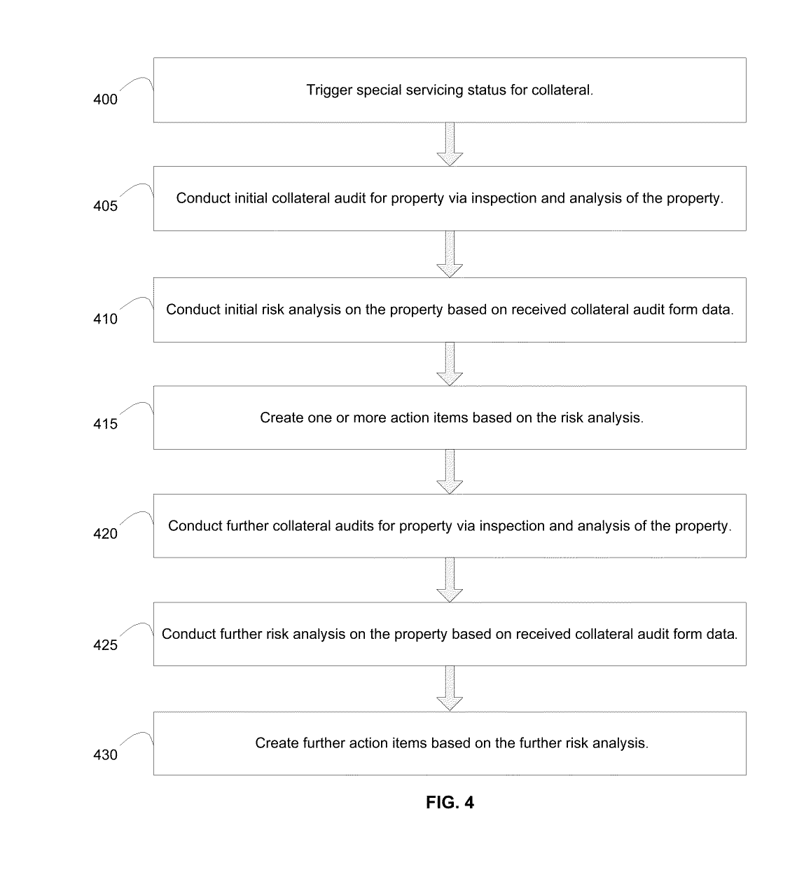

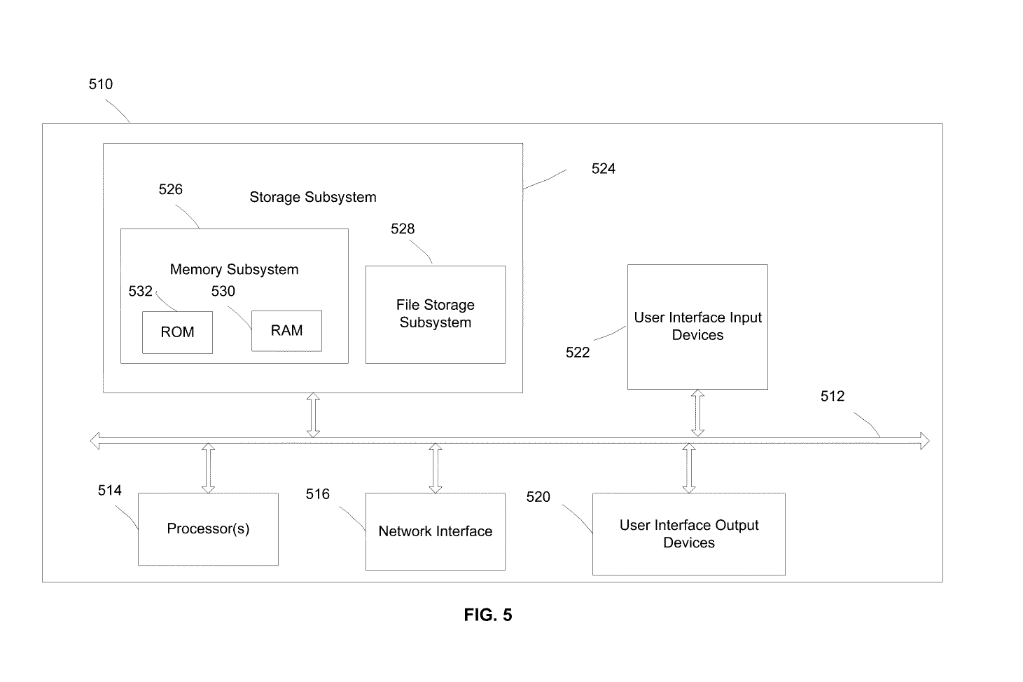

FIG. 4 illustrates a flow chart of an implementation of steps for monitoring risks for collateral and mitigating the risks for the collateral. Other implementations may perform the steps in a different order, omit certain steps, and/or perform different and/or additional steps than those illustrated in FIG. 4. For convenience, aspects of FIG. 4 will be described with reference to a system of one or more computers that perform the process. In some implementations the system may include, for example, the collateral audit engine 130. In some implementations the system may additionally or alternatively include any number of client computing devices 110 of FIG. 1. In some implementations the system may additionally or alternatively include any number of collateral audit engines 120 of FIG. 1.

At step 400, special servicing status for collateral is triggered. For example, a special servicing status may be activated when a borrower is issued a delinquency notice, a property has been foreclosed, and/or the property has been sold. In some implementations the special servicing status may be activated based on a date when the collateral needs to be reassessed so that any changes to the collateral over time can be addressed via subsequent action items. In some implementations a special servicing trigger may be set up so that the property is triggered for special servicing status and reassessed once a year. In some implementations the special servicing status may be automatically determined by the collateral information engine 130 based on provided data. In some implementations the special servicing status may be set manually by a user.

At step 405, an initial collateral audit for the property is conducted through an inspection and analysis of the property. The initial entry of the data into the collateral information system 130 allows the system to begin to keep track of the data from the property in order to make future assessments of the risks involved with the property. In some implementations the initial collateral audit of step 405 will share one or more common aspects with step 200 of FIG. 2. In some implementations information from an inspection may result in data from the collateral audit being stored for later use in further analysis of the property.

At step 410 the system and/or a user conducts an initial risk analysis based on the audit information that is gathered via inspection in step 405. The initial risk analysis is based on the audit information and determines one or more action items that may pose a direct and/or indirect risk to the property. In some implementations an initial risk analysis is determined based on the condition of the property. If the property is generally in good condition, the risk management system may determine that the risk to the property is low and not identify any action items to address. If the property is in a state of disrepair, such as broken windows, leaking roof, and/or other critical criteria, then one or more action items may be identified as needing to be addressed.

At step 415 one or more action items may be created in order to address the identified risks associated with the collateral. The collateral information engine 130 may create an action item based on the risk analysis performed at step 410. The action item indicates that an action may be required based on the collected collateral audit form data at step 405 and/or the risk analysis at step 410. For example, the collateral information engine 130 may create action items for boiler maintenance, pipe winterization, and/or roof repairs based on the state of the property as assessed in step 410.

At step 420, further collateral audits are conducted on the property via inspection and analysis of the property. In some implementations subsequent collateral audits may be activated based on a change in the status of the property, such as when a property is foreclosed upon. In some implementations the action item for a subsequent audit may be activated using a specific date, such as one month after the last inspection.

At step 425, further risk analysis is optionally conducted on the collateral based on data received from subsequent collateral audits. The further risk analysis may be based on similar criteria and/or performed in a similar manner as the risk analysis conducted in step 410 using the data collected in collateral audits.

At step 430, one or more action items are created based on further risk analysis that may be generated from subsequent collateral audits. These may optionally be created in a manner similar to the action items created in step 415 and may be based on the risk analysis conducted in step 425.

FIG. 5 is a block diagram of an example computer system 510. Computer system 510 typically includes at least one processor 514 which communicates with a number of peripheral devices via bus subsystem 512. These peripheral devices may include a storage subsystem 524, including, for example, a memory subsystem 526 and a file storage subsystem 528, user interface input devices 522, user interface output devices 520, and a network interface subsystem 516. The input and output devices allow user interaction with computer system 510. Network interface subsystem 516 provides an interface to outside networks and is coupled to corresponding interface devices in other computer systems.

User interface input devices 522 may include a keyboard, pointing devices such as a mouse, trackball, touchpad, or graphics tablet, a scanner, a touchscreen incorporated into the display, audio input devices such as voice recognition systems, microphones, and/or other types of input devices. In general, use of the term “input device” is intended to include all possible types of devices and ways to input information into computer system 510 or onto a communication network.

User interface output devices 520 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computer system 510 to the user or to another machine or computer system.

Storage subsystem 524 stores programming and data constructs that provide the functionality of some or all of the modules described herein. For example, the storage subsystem 524 may include the logic to methods for analysis and maintenance of collateral according to one or more processes described herein.

These software modules are generally executed by processor 514 alone or in combination with other processors. Memory 526 used in the storage subsystem can include a number of memories including a main random access memory (RAM) 530 for storage of instructions and data during program execution and a read only memory (ROM) 532 in which fixed instructions are stored. A file storage subsystem 528 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 528 in the storage subsystem 524, or in other machines accessible by the processor(s) 514.

Bus subsystem 512 provides a mechanism for letting the various components and subsystems of computer system 510 communicate with each other as intended. Although bus subsystem 512 is shown schematically as a single bus, alternative implementations of the bus subsystem may use multiple busses.

Computer system 510 can be of varying types including a workstation, server, computing cluster, blade server, server farm, or any other data processing system or computing device. Due to the ever-changing nature of computers and networks, the description of computer system 510 depicted in FIG. 5 is intended only as a specific example for purposes of illustrating some implementations. Many other configurations of computer system 510 are possible having more or fewer components than the computer system depicted in FIG. 5.

FIGS. 6A-6A1 illustrate aspects of an example graphical user interface that may be implemented in embodiments of the collateral audit engine 120. FIGS. 6A-6C list example categories of information that may be gathered in an assessment of collateral at the initial stages of collateral audit data acquisition or when subsequent evaluations are conducted. FIGS. 6D-6A1 show example graphical interfaces for entering information via a collateral input engine 120. The Interfaces shown in FIGS. 6A-6A1 may be implemented on one or more collateral audit engines 120. In some implementations collateral audit engine 120 may be a tablet computing device. In another implementation the collateral audit engine 120 may be a smartphone.

In some implementations, the interface may allow the site evaluator to take photos of parts of the collateral in order to later assess specific aspects of the collateral more accurately. For example, FIG. 60 has an entry for the hot water system of a building. The entry allows the evaluator to enter observed data about the heater (type, age, condition, etc.) and a photo of the heater is added so that others who were not present at the property inspection may better see the hot water heater. In some implementations, the photos may be taken with a peripheral camera attached to collateral audit engine 120. In some implementations, the photos may be taken with a separate camera and later uploaded to the collateral audit engine 120, to the collateral information engine 130, and/or to the content database 115.

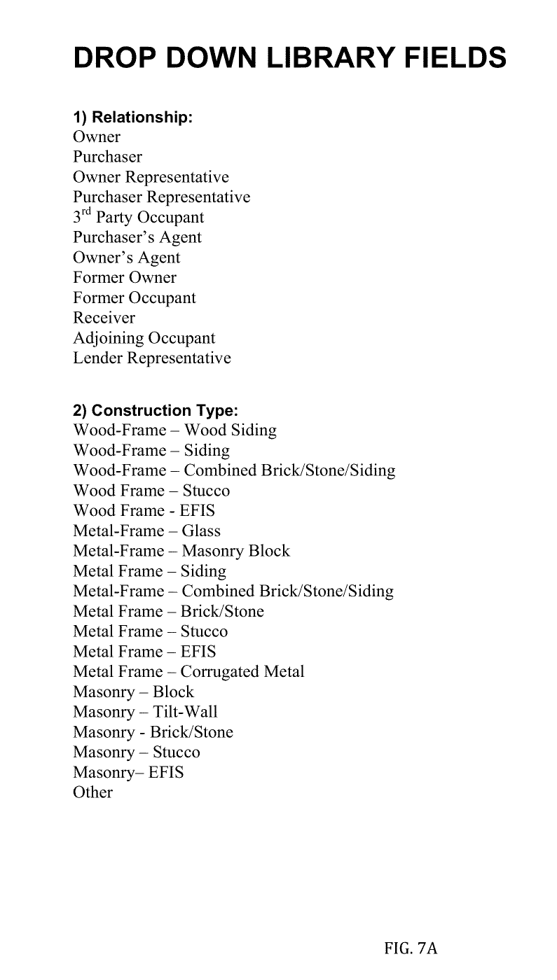

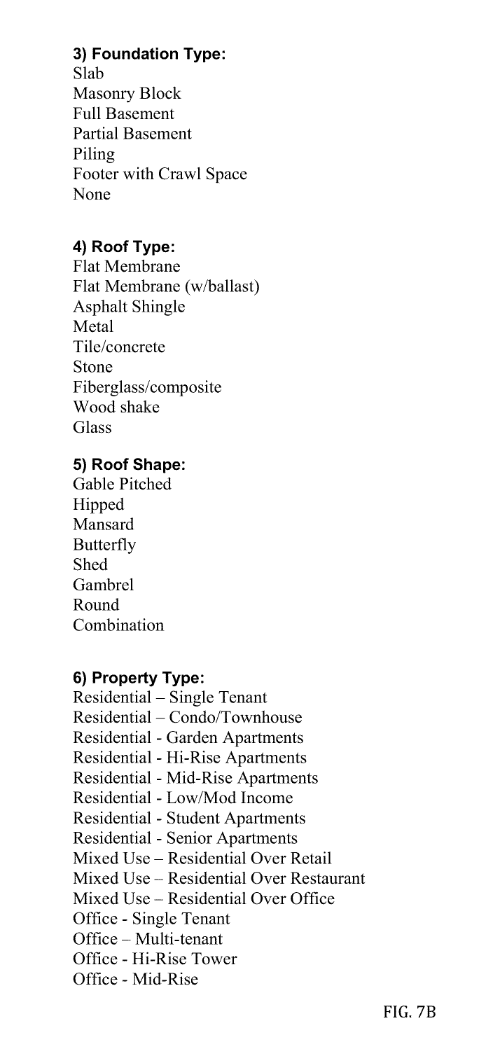

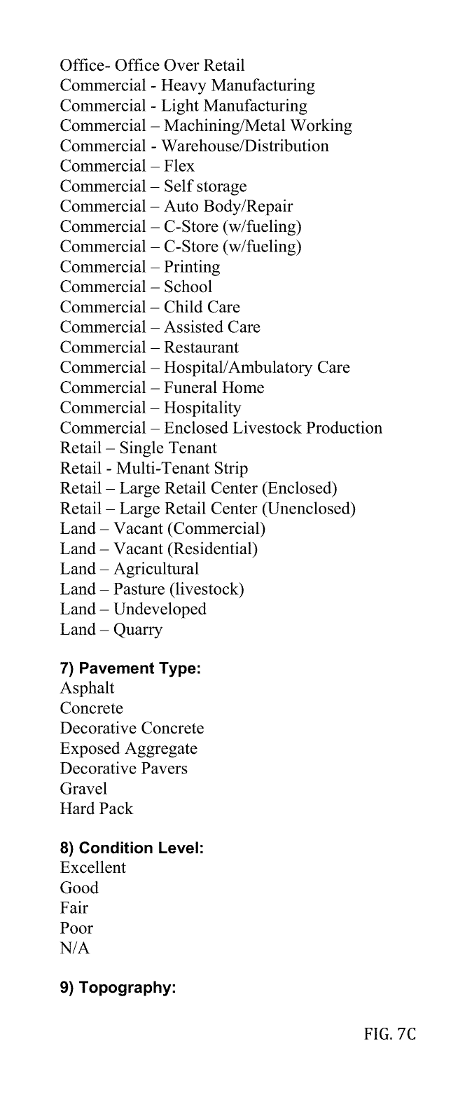

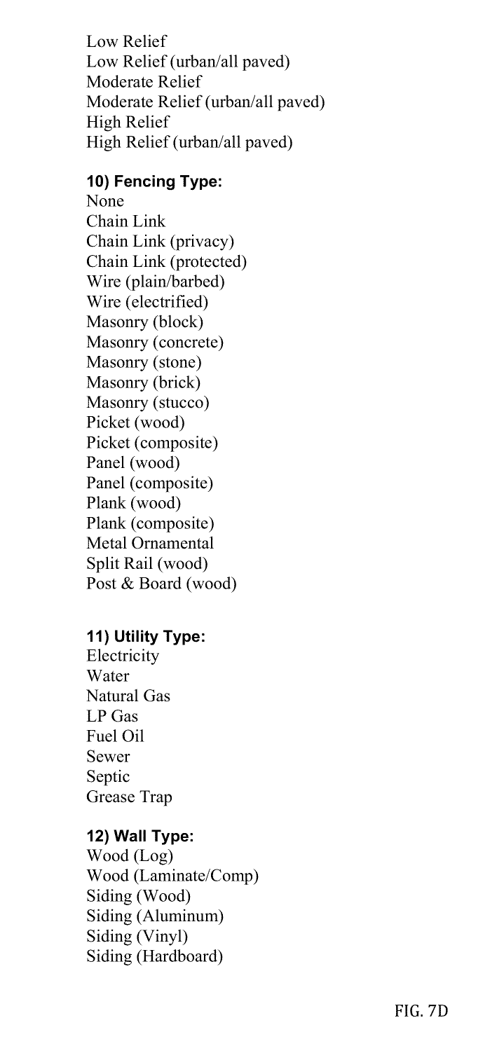

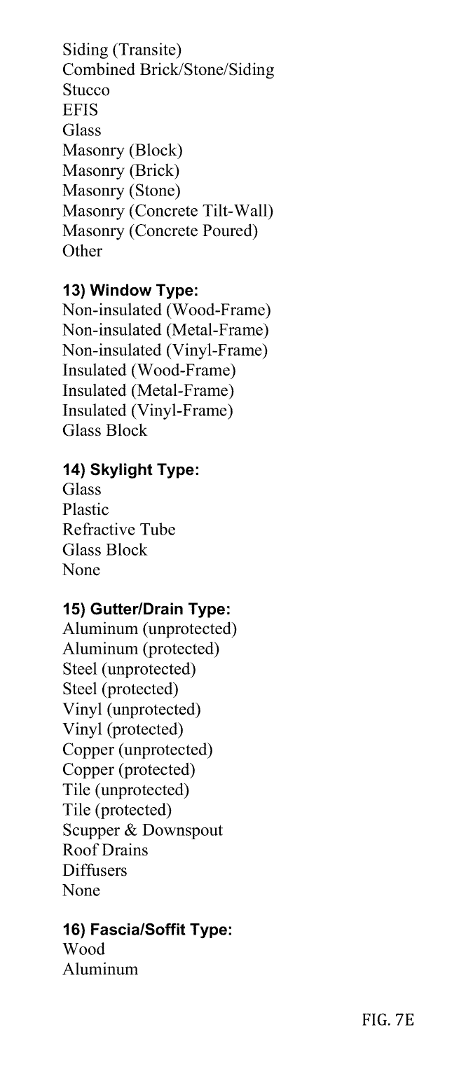

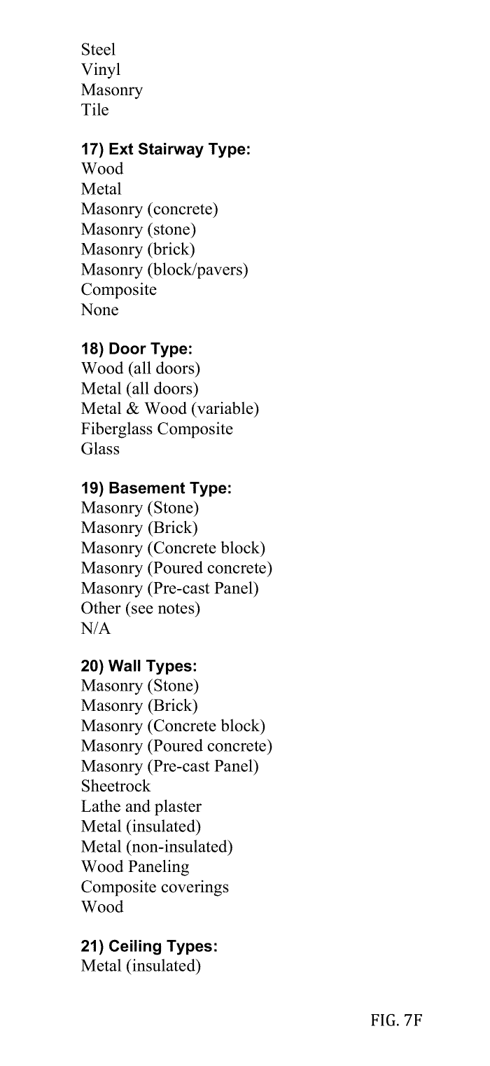

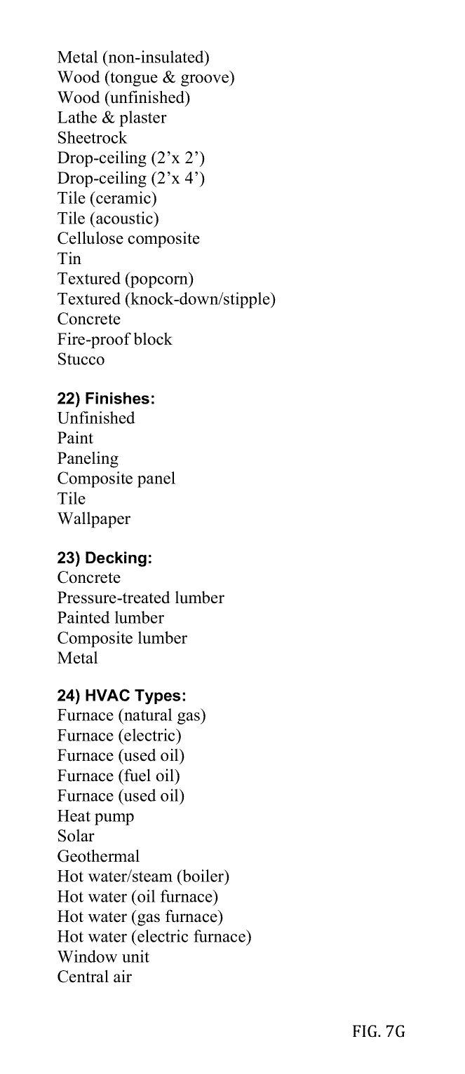

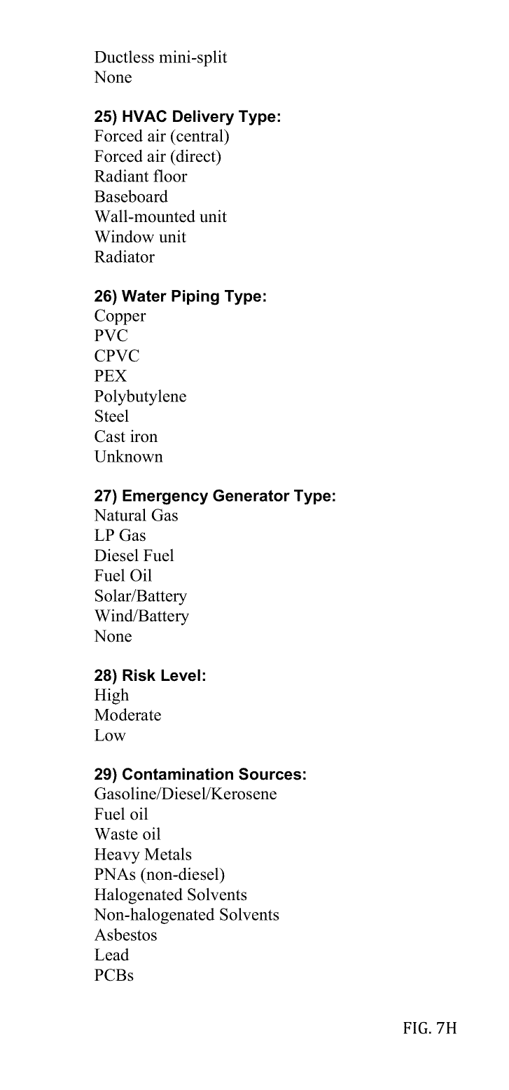

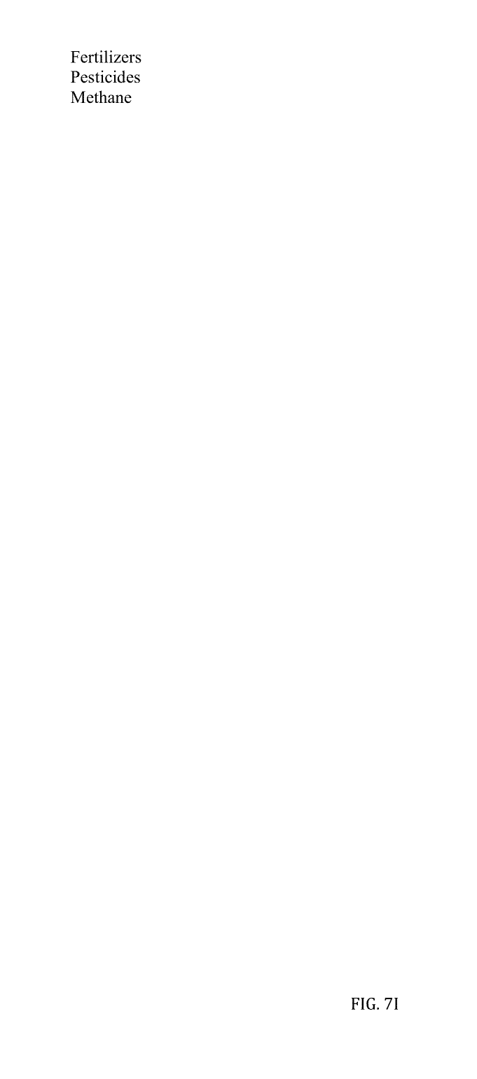

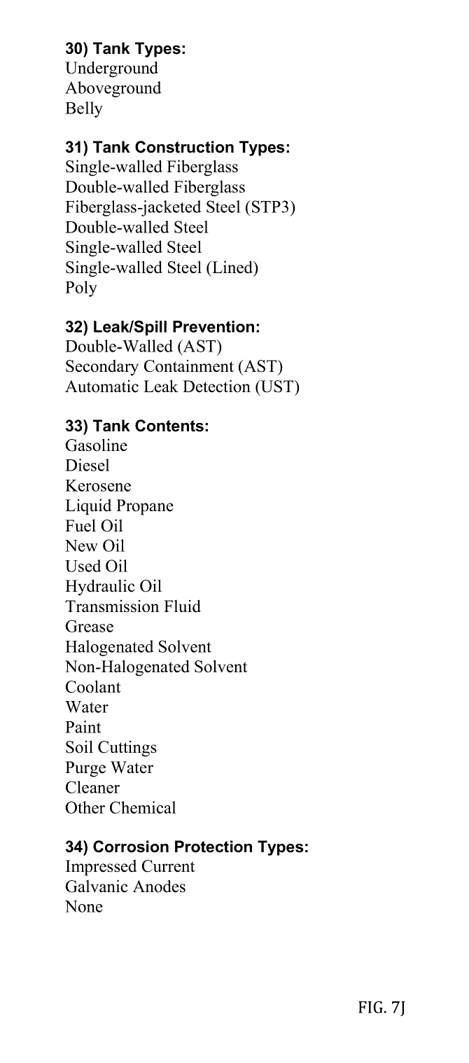

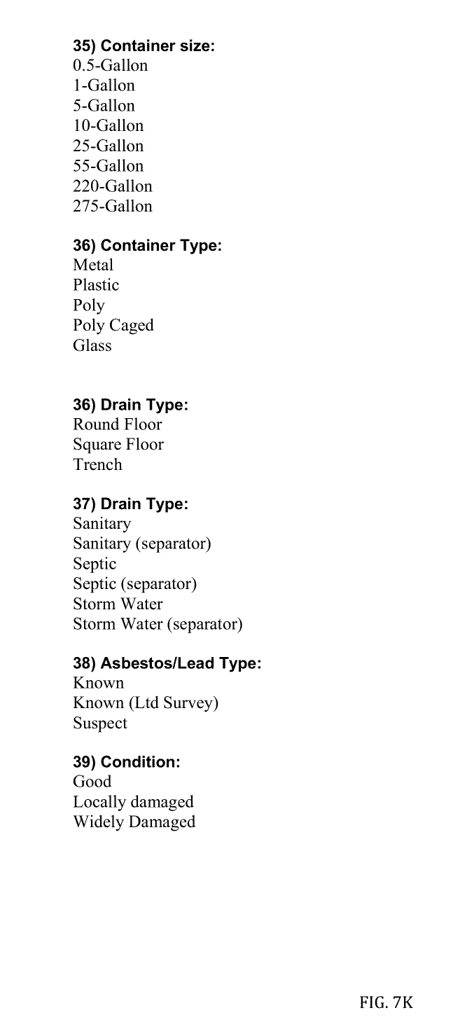

In some implementations, the user may describe the condition and type of an improvement or feature of the property through the use of drop-down menus. The inspector may be given a limited number of choices to describe each feature in order to standardize the data for storage. For example, in FIG. 6G, the inspector is given a number of choices of how to describe the paving; in the illustrated implementation, concrete. The inspector then has a number of choices for how to describe the condition of the pavement; in the illustrated implementation, poor. The inspector may also have the option to include details and/or notes about a specific aspect of the collateral. FIGS. 7A-7K show examples of the types of selections the site evaluator can make for each of the categories of information that are exemplified in FIGS. 6A-6A1. For example, the site evaluator may be prompted to enter a description of the type of windows on a building (FIG. 61). A drop-down box gives the evaluator a number of choices, with the choice “Non-insulated” chosen in FIG. 61. In this implementation, the evaluator had a number of selections for this category, listed in FIG. 7E. In the illustrated implementation, the inspector has the option to add notes and/or details for each entry.

FIGS. 8A-8H show example implementations of a graphical user interface for a collateral information engine as described herein. The illustrated graphical user interface may be displayed on one or more client computing devices 110 and be generated and/or populated by the collateral information engine 130. The primary navigator screen is illustrated in FIG. 8A and contains general information about the property (8A.1) (e.g., project number, project name, address, and/or city), general information on the risk level of the property (8A.2) (e.g., risk level, value of the collateral, and/or risk exposure), and four possible categories in which to classify various action items in action item display boxes (8A.3-8A.6) (e.g., servicing, third party, collateral, and tangible collateral action items). The top of the navigator (8A.7) has tabs (e.g., servicing, third party, collateral, and/or tangible collateral) in order to navigate between various detailed screens for each category (8B, 8F, 8H). The general risk level assessment (8A.2) shows the aggregate risk level, value of the property, estimated exposure and mitigation costs, and past expenditures on the property.

For each of the action item display boxes (8A.3-8A.6), a description of the action item, the set trigger for the action item, its priority level, and status of the action item are displayed. Each box also contains entries for the aggregate risk level, expenditure and mitigation costs, status of each action item, and the amount spent to date on that category.

FIG. 8B shows an example of a detailed summary of one of the categories of action items; in this case, for collateral action items (see 8A.4). The screen shows general information about the property (8B.1), information about the various improvements, systems, and status of the property (8B.2), and details of the action items that fall into that category (8B.3). By highlighting an action item, the exposure and mitigation costs, any contractor bids for that action item, and amount spent so far on that action item are displayed above the action item list 8B.3.

FIGS. 8C, 8D, and 8G show pop-up boxes for editing information about the property. The pop-up windows appear when a category is clicked on a detailed navigator screen. When the pop-up window appears, a user can edit information that was originally gathered by an inspection. The condition level of the improvement, the type of improvement, and/or the detailed notes about the property can be edited as needed. For example, FIG. 8C shows a pop-up box for editing information about the roof of a property. The pop-up box has options for the user to change the condition level of the roof, to change the type of the roof, to update the details for the roof, and/or to save those changes. The new information can be stored for later access and/or analysis. FIG. 8E shows a similar pop-up window that allows a user to update an action item.

FIGS. 8B-8H show example implementations of the dashboard for each category of action items (e.g., servicing, third party, collateral, and/or tangible collateral). The bottom right of the screen shows pending action items, each action item's risk level, and whether the action item is still open or has been completed (i.e., “closed”). The total exposure cost, mitigation cost, and aggregate risk level are shown above the action item list. The top of the screen shows general collateral information such as address, project name, and occupancy status. The remainder of the screen shows the information that was gathered during a site evaluation and allows a user to alter some of the entries based on changes in the audit data, such as the water being subsequently shut off. Information on these items can be updated either through the collateral services dashboard or via pop-up windows, as shown in FIGS. 8C-8E and FIGS. 8G-8H.

Access to view and/or modify parts of the data navigation interface may vary depending on the type of user who is logged into the system. For example, a legal representative may only have access to view and/or modify legal-related action items. Also, for example, a manager for the lender may be able to view and/or modify all of the information related to a property. Also, for example, a third-party contractor may not have access to identifying information about the borrower and may only be able to view the action items that are related to the jobs involving that business' contracts and/or bids.

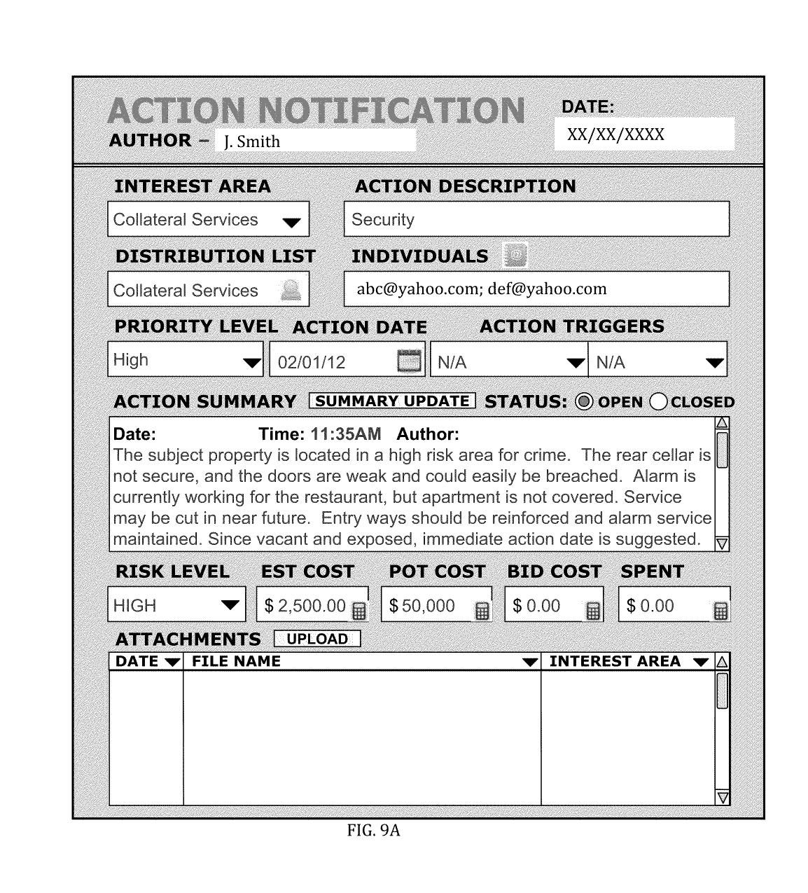

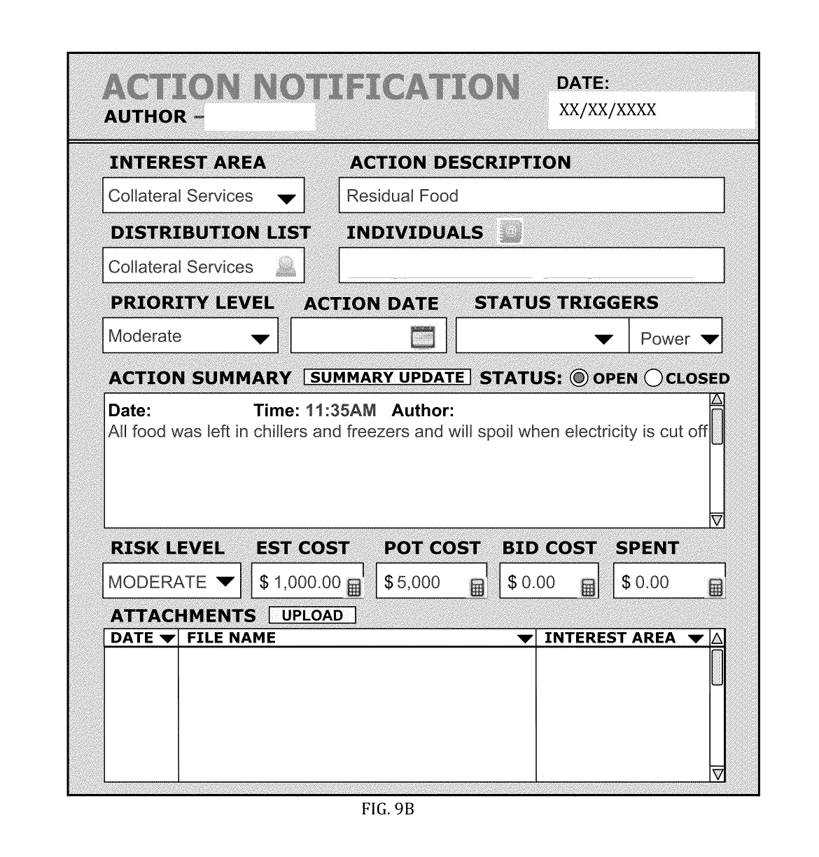

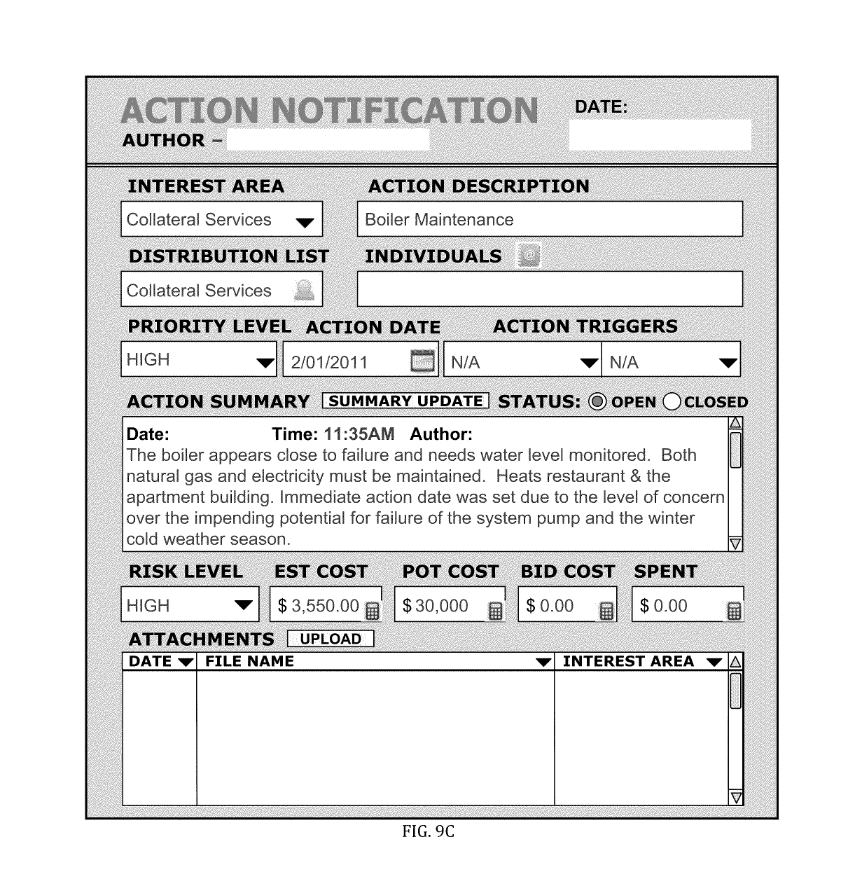

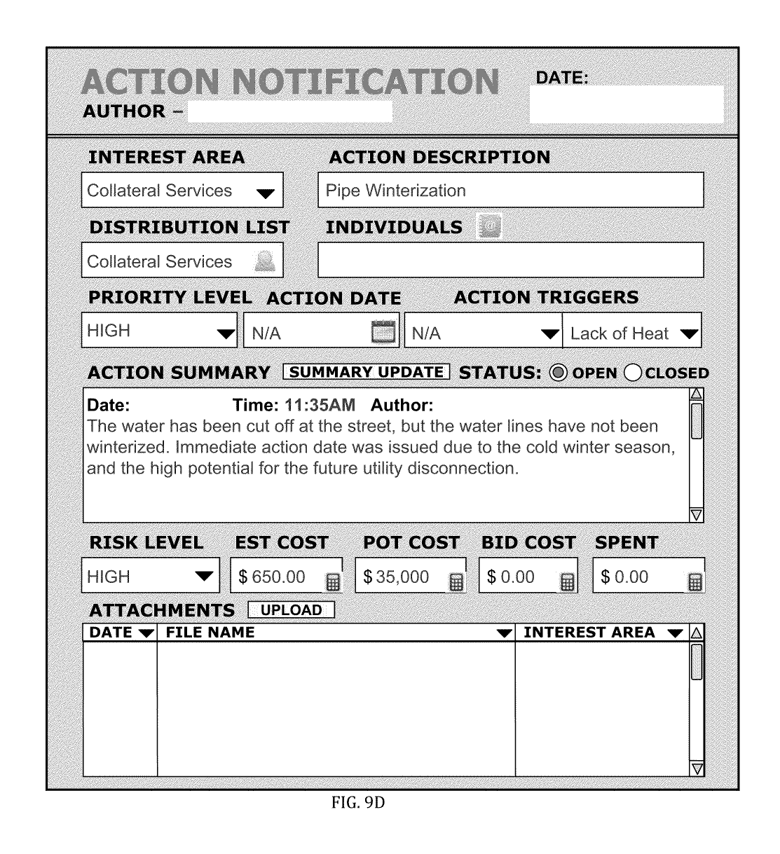

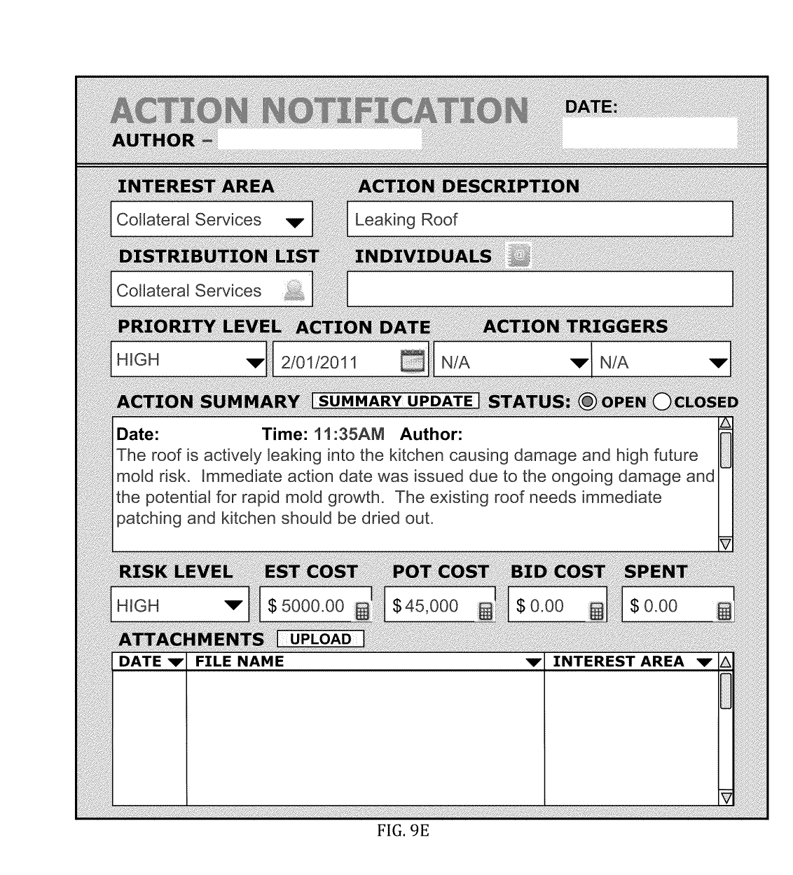

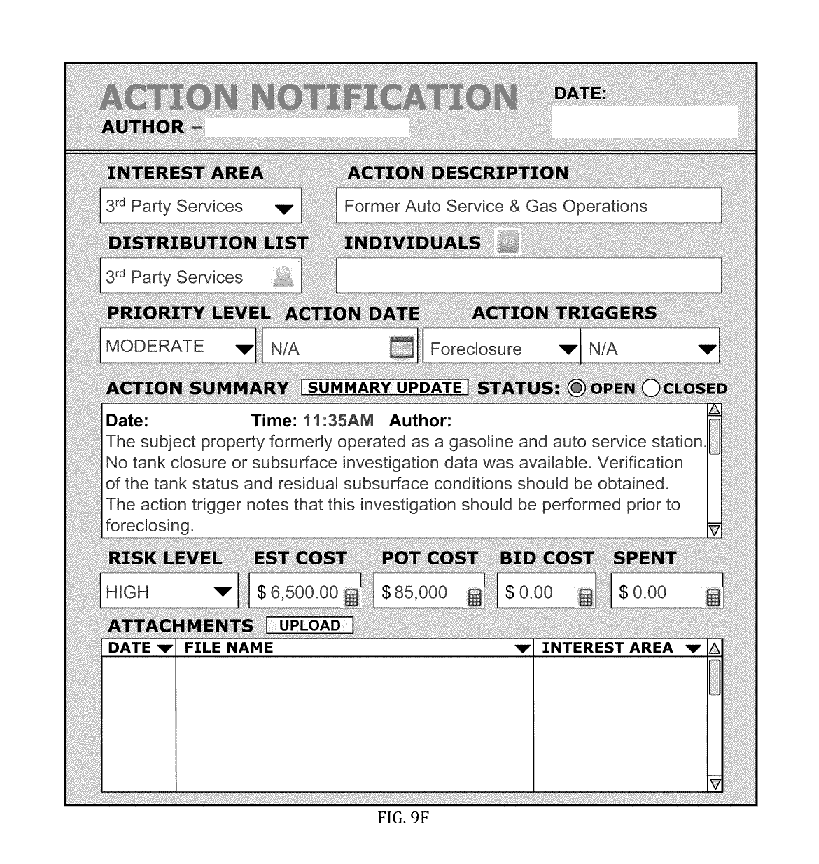

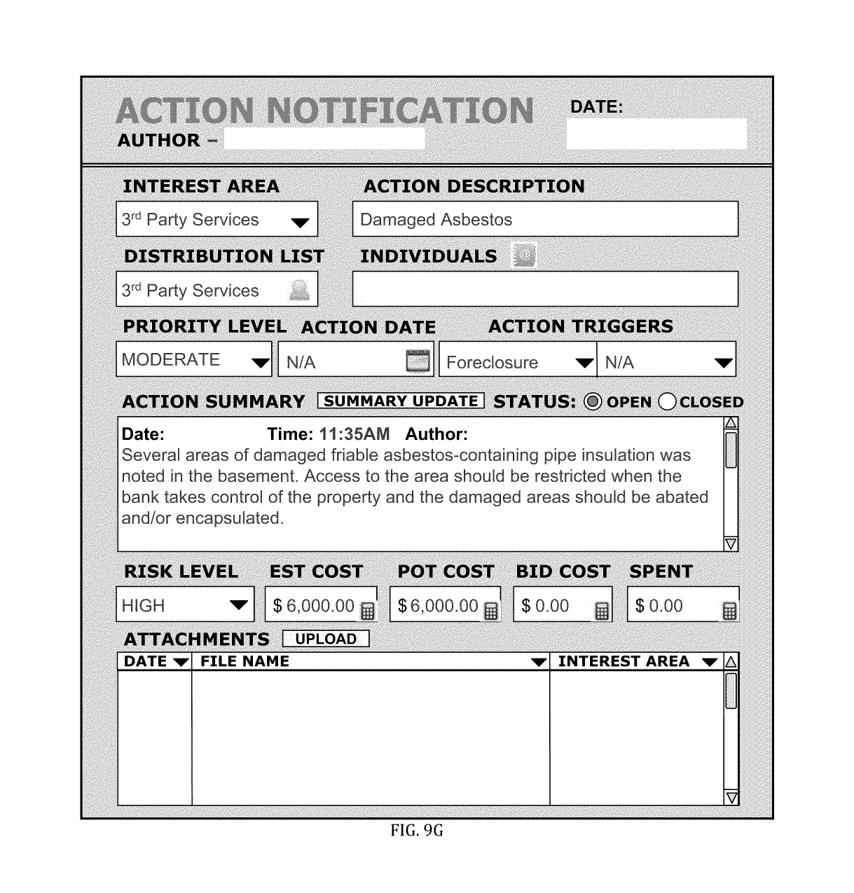

FIGS. 9A-9G show implementations for action item notifications. Each action notification screen has editable fields to allow a user to change information about the action item, such as trigger dates, trigger actions, setting the status of the action item, and updating the exposure and mitigation costs. The action item notification screen may appear as a pop-up screen within the risk management program. The action item notification may appear when a user should be alerted to the action item and/or when the user clicks on an action item.

FIG. 9A shows example action item notifications for a security action item. The action item notification notes the action item author's name, the date that the action item was created, the category of the action item (in this example, collateral services), a description of the action item, and information about who is notified of the action item (e.g., by individual' emails and/or by distribution lists). The action item notification may also list detailed information about the action item, such as the priority level of the action item, the triggers which activate the action item, a written description of the details of the action item, the risk level of the action item, and the past and future costs associated with the action item (e.g., exposure costs, mitigation costs, and/or past expenditures). A user may upload additional information to associate with the action item, such as supplemental files.

FIG. 9B shows an action item notification for an action item to clean out the freezers of a property. The action item has a status trigger for power, which triggers the action item whenever the status of the power is changed (e.g., power is cut off).

FIG. 9C shows an action item notification for an action item to perform boiler maintenance. The boiler maintenance has been set to high priority and the action summary gives a summary of the condition of the boiler, what needs to be maintained, and why the maintenance is a high priority. The action item notification has an estimated cost to repair and a potential cost if the repairs are not performed.

FIG. 9D shows an action item notification for an action item to winterize pipes. The action item is triggered when the property's heat is disconnected.

FIG. 9E shows an action item notification for an action item to fix a leaking roof. The priority level is set to high to reflect the urgency of the situation, as detailed in the action summary.

FIG. 9F shows an example of an action item notification for an action item that is triggered by a status change; in this example, by foreclosure. The action item is to have the property investigated prior to foreclosure. The action item must be performed before foreclosure proceedings can continue.

FIG. 9G shows another example of an action item notification for an action item that is triggered by a status change; in this example, foreclosure. In this action item, the property has damaged asbestos and the property needs to be secured before the bank takes control of the property.

Although specific implementations of a graphical user interface are described herein, one of ordinary skill in the art, having had the benefit of the present disclosure, will recognize and appreciate that other graphical user interfaces may be utilized. The graphical user interfaces that are illustrated in FIGS. 6A-9G are examples of certain implementations of the system that is described herein.

While several inventive implementations have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive implementations described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive implementations described herein. It is, therefore, to be understood that the foregoing implementations are presented by way of example only and that, within the scope of the appended claims and equivalents thereto, inventive implementations may be practiced otherwise than as specifically described and claimed. Inventive implementations of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over vocabulary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one implementation, to A only (optionally including elements other than B); in another implementation, to B only (optionally including elements other than A); in yet another implementation, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one implementation, to at least one, optionally including more than one, A, with no B present (and optionally including elements other than B); in another implementation, to at least one, optionally including more than one, B, with no A present (and optionally including elements other than A); in yet another implementation, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A computer implemented method for monitoring real estate collateral, comprising:
receiving collateral audit form data, said collateral audit form data including on-site analysis data verified via on-site analysis of said real estate collateral;
analyzing said collateral audit form data;
creating an action item for said real estate collateral;
determining an initial risk level for said action item;
calculating a potential exposure cost for said action item;
estimating a mitigation cost for said action item;
assigning a risk level trigger to said action item, said risk level trigger based on at least one of a calendar date, a status milestone related to said real estate collateral, geographic location of said real estate collateral, and a specific condition of said real estate collateral;
raising, utilizing one or more processors, said initial risk level to an elevated risk level in response to said risk level trigger occurring; and
creating a user notification of said elevated risk level.

2. The method of claim 1, further comprising assigning said initial risk level for said action item based on at least one of a current calendar date, current status milestones related to said real estate collateral, said geographic location of said real estate collateral, and current specific conditions of said real estate collateral.

3. The method of claim 1, wherein said potential exposure cost for said action item is estimated, utilizing one or more processors, and is based on analysis of a database of similar potential exposure costs.

4. The method of claim 1, wherein said estimated mitigation cost for said action item is estimated, utilizing one or more processors, and is based on analysis of a database of similar estimated mitigation costs.

5. The method of claim 1, further comprising receiving a mitigation bid for said action item and replacing said estimated mitigation cost with said mitigation bid.

6. The method of claim 1, further comprising automatically soliciting, utilizing one or more processors, bids from a plurality of contractors.

7. The method of claim 6, wherein said step of automatically soliciting is performed in response to said step of raising said initial risk level to said elevated risk level.

8. A computer implemented method for monitoring real estate collateral, comprising:
receiving collateral audit form data for real estate collateral, said collateral audit form data including on-site analysis data verified via on-site analysis of said real estate collateral;
analyzing said collateral audit form data to create an action item for said real estate collateral;
determining an initial risk level for said action item;
determining a potential exposure cost for said action item;
determining an estimated mitigation cost for said action item; and
assigning a risk level trigger to said action item;
raising, utilizing one or more processors, said initial risk level to an elevated risk level in response to said risk level trigger occurring;
creating and transmitting a user notification containing said elevated risk level;
receiving a notification of completion of said action item and assigning a completed status to said action item in response to receiving said notification of completion;
creating a second action item for said real estate collateral;
receiving a second action item notification of completion of said second action item and assigning a second action item completed status to said second action item in response to receiving said second action item notification of completion;
wherein said second action item notification of completion is only assignable when said completed status is assigned to said action item.

9. The method of claim 8, wherein said action item is a collateral preservation action item related to at least one of physically fixing and physically maintaining said real estate collateral.

10. The method of claim 8, wherein said action item is a legal action item related to legal requirements for processing of said real estate collateral.

11. The method of claim 10, wherein said second action item is a collateral preservation action item related to at least one of physically fixing and physically maintaining said real estate collateral.

12. The method of claim 8, further comprising automatically soliciting, utilizing one or more processors, bids from a plurality of contractors for said second action item.

13. The method of claim 12, wherein said step of automatically soliciting is only performed when said completed status is assigned to said action item.

14. The method of claim 8, wherein said risk level trigger is based on at least one of a calendar date, a status milestone related to said real estate collateral, geographic location of said real estate collateral, and a specific condition of said real estate collateral.

15. The method of claim 8, wherein said risk level trigger is based on said status milestone related to said real estate collateral.

16. The method of claim 15, wherein said status milestone related to said real estate collateral includes at least one of special servicing, pre-foreclosure, vacate, utilities cut, and real estate owned.

17. The method of claim 8, further comprising automatically assigning said initial risk level for said action item based on at least one of a current calendar date, current status milestones related to said real estate collateral, said geographic location of said real estate collateral, and current specific conditions of said real estate collateral.

18. The method of claim 8, wherein said potential exposure cost for said action item is automatically determined, utilizing one or more processors, and is based on analysis of a database of similar potential exposure costs.

19. The method of claim 18, wherein said estimated mitigation cost for said action item is automatically determined, utilizing one or more processors, and is based on analysis of a database of similar estimated mitigation costs.

20. The method of claim 8, wherein said step of receiving said notification of completion of said action item and assigning a completed status to said action item in response to receiving said notification of completion includes receiving and storing an invoice of work related to said action item.
